(19) United States
(12) Patent Application Publication
(10) Pub. No.: US 2026/0117119 A1
(43) Pub. Date: Apr. 30, 2026

(54) FLUORESCENT COMPOSITE PARTICLE AND PREPARATION METHOD THEREOF

(71) Applicant: DALIAN LIHENG TECHNOLOGY CO., LTD., Dalian City (CN)

(72) Inventors: Liang LI, Shanghai (CN); Mengda HE, Shanghai (CN); Qinggang ZHANG, Shanghai (CN); Weiyu WEI, Shanghai (CN); Long KONG, Shanghai (CN)

(73) Assignee: DALIAN LIHENG TECHNOLOGY CO., LTD., Dalian City (CN)

(21) Appl. No.: 19/120,505

(22) PCT Filed: Oct. 13, 2023
(86) PCT No.: PCT/CN2023/124578

§ 371 Date: Jan. 14, 2026

(30) Foreign Application Priority Data
Oct. 13, 2022 (CN) 202211255720.3

(51) Int. Cl. C09K 11/61; C09K 11/88

(52) U.S. Cl. CPC C09K 11/616; C09K 11/883

(57) ABSTRACT

Some embodiments of the disclosure provide a fluorescent composite particle. In some examples, the fluorescent composite particle includes a fluorescent material having a plurality of fluorescent nanocrystals, and an oxide material. The fluorescent material is densely coated with the oxide material, and a molar ratio of the fluorescent material to the oxide material is 10:1 to 1:100. The fluorescent composite particle has a particle size of 20 nm to 500 nm, a density of 1.8 g/cm3 to 7 g/cm3, and a specific surface area of 8 m2/g to 200 m2/g. According to some embodiments of the present disclosure, the fluorescent composite particle having high stability and small particle size may be provided. Moreover, the present disclosure further provides two preparation methods for obtaining a fluorescent composite particle having a predetermined morphology.

### CROSS REFERENCE TO RELATED APPLICATIONS

This application is the United State national stage entry under 37 U.S.C. 371 of PCT/CN2023/124578, filed on Oct. 13, 2023, which claims priority to Chinese application number 202211255720.3, filed on Oct. 13, 2022, the disclosure of which are incorporated by reference herein in their entireties.

### FIELD OF THE DISCLOSURE

The disclosure relates generally to new materials. More specifically, the disclosure relates to fluorescent composite particles and preparation methods thereof.

### BACKGROUND

Nanocrystals are of a new type of luminescent materials, which have the advantages of high fluorescence quantum efficiency, adjustable emitting color, high color purity, etc., and are widely applied in the field of optoelectronic devices. Most of the traditional preparation methods of nanocrystals are carried out in solutions, such as a high-temperature thermal injection method, a water-in-oil method, a coordination synthesis method, etc. However, the nanocrystals synthesized by these technologies have poor stability and are easily corroded and decomposed by light, heat, moisture, oxygen, etc. In addition, the current solution synthesis technologies require the use of organic ligands and a large amount of organic solvents or water, and the synthesis process and the purification process will produce a large amount of waste liquid to cause environmental pollution, which directly affects the application prospect of the nanocrystals.

In order to improve the stability of the nanocrystals, the nanocrystals are usually coated with inorganic materials such as silicon dioxide, titanium dioxide and aluminum oxide. For example, a nanocrystal oxide complex is obtained by a liquid phase coating method: an oxide precursor is hydrolyzed in a solution so that an oxide is formed around nanocrystals for coating. However, oxide shells formed by these coating technologies are usually loose and cannot completely block the corrosion of nanocrystal fluorescent materials by moisture and oxygen, and the light and thermal stability of the nanocrystal fluorescent materials still cannot meet the needs of practical applications. Therefore, there are methods for encapsulating nanocrystals inside oxides in situ by using high-temperature solid-phase synthesis and in-situ encapsulation at present. Specifically, oxides and nanocrystals are sintered at high temperature, the high temperature will cause the oxides to soften and collapse, and the nanocrystals are coated with the oxides, thereby obtaining composite particles with high compact level.

However, in a high-temperature solid-phase method, the agglomeration and adhesion between particles may be caused during high-temperature sintering, resulting in an uncontrollable morphology and large particle size (generally greater than 10 microns) of a final synthesized complex. The nanocrystal oxide complex of this size and morphology is difficult to process in a solution (e.g., having poor dispersion in the solution), which directly affects the application prospect of the nanocrystal oxide complex (e.g., limits its applications in the field of high-quality display such as Micro-LED and the field of biological imaging).

### SUMMARY

The following presents a simplified summary of the invention in order to provide a basic understanding of some aspects of the invention. This summary is not an extensive overview of the invention. It is not intended to identify critical elements or to delineate the scope of the invention. Its sole purpose is to present some concepts of the invention in a simplified form as a prelude to the more detailed description that is presented elsewhere.

A first aspect of the present disclosure provides a fluorescent composite particle. The fluorescent composite particle includes a fluorescent material having a plurality of fluorescent nanocrystals, and an oxide material, wherein the fluorescent material is densely coated with the oxide material, a molar ratio of the fluorescent material to the oxide material is ranged from 10:1 to 1:100, and the fluorescent composite particle has a particle size of 20 nm to 500 nm, a density of 1.8 g/cm³ to 7 g/cm³, and a specific surface area of 8 m²/g to 200 m²/g.

In the first aspect of the present disclosure, the fluorescent composite particle includes the fluorescent material and the oxide material, wherein the fluorescent material may enable the fluorescent composite particle to have good photoelectric properties and fluorescent characteristics, the fluorescent material is densely coated with the oxide material, and the fluorescent composite particle has a density of 2 g/cm³ to 3 g/cm³, and a specific surface area of 10 m²/g to 200 m²/g; and the oxide material may play a good role in protecting the fluorescent material, reduce the influence of an external environment on the fluorescent material, and improve the overall stability. In addition, the fluorescent composite particle has a particle size of 20 nm to 500 nm. This small-size fluorescent composite particle may be easily processed in a solution and may further be applied in the field of high-quality display such as Micro-LED, the field of biological imaging and other fields.

In the fluorescent composite particle involved in the first aspect of the present disclosure, optionally, the fluorescent nanocrystal has a particle size of 1 nm to 50 nm. In this case, fluorescent nanocrystals have good optoelectronic properties and fluorescent characteristics, which may make the composite particle have good overall photoelectric properties and fluorescent characteristics, as well as small overall particle size.

In the fluorescent composite particle involved in the first aspect of the present disclosure, optionally, the plurality of fluorescent nanocrystals are uniformly dispersed inside the oxide material, and a difference between the particle sizes of any two fluorescent nanocrystals in the plurality of fluorescent nanocrystals is ranged from 0 nm to 25 nm. In this case, the fluorescent characteristics of the plurality of nanocrystals are less different, which may make the fluorescent composite particle have higher fluorescent color purity.

In the fluorescent composite particle involved in the first aspect of the present disclosure, optionally, the fluorescent material has cations, and oxygen ions of the oxide material form bonds with the cations of the fluorescent material for lattice anchoring. Therefore, it is facilitated for the oxide material to be combined with the fluorescent material, so as to further improve the stability of the fluorescent composite particle.

In the fluorescent composite particle involved in the first aspect of the present disclosure, optionally, the fluorescent material includes fluorescent nanocrystals having a perovskite structure ABX₃, wherein A is Li, Na, K, Rb or Cs, B is Ge, Sn, Pb, Cu, Mn, Ca, Sr or Ba, and X is F, Cl, Br or I.

In the fluorescent composite particle involved in the first aspect of the present disclosure, optionally, the fluorescent material includes fluorescent nanocrystals having a perovskite structure ABX₃ modified with a halide; the halide has a perovskite-type or non-perovskite-type structure; the halide has a structure of B′X₂, A′B′X₃, A′₄B′X₆ or A′B′₂X₅, and A′ and A are independently Cs, Rb or K; B′ and B are independently Pb, Zn, Ca or Ba; and X is Cl, Br or I.

In the fluorescent composite particle involved in the first aspect of the present disclosure, optionally, the fluorescent material includes fluorescent nanocrystals having a binary structure Dⁿ⁺Yⁿ⁻, wherein n is an integer of 1-10, a molar ratio of elements D to Y is 1:1, and D is Zn, Cd, Hg, Al, Ga or In; and Y is S, Se, Te, N, P, As or Sb.

In the fluorescent composite particle involved in the first aspect of the present disclosure, optionally, the fluorescent material includes fluorescent nanocrystals having an IB-IIIA-VIA family ternary compound structure G⁺M³⁺ (N²⁻)₂, wherein G⁺ is Cu⁺ or Ag⁺; M³⁺ is In³⁺, Ga³⁺ or Al³⁺; N²⁻ is S²⁻ or Se²⁻; and a molar ratio of G⁺ to M³⁺ to N²⁻ is 0.5:0.5:1.

In the fluorescent composite particle involved in the first aspect of the present disclosure, optionally, the oxide material is selected from any one of silicon oxide, aluminum oxide, titanium oxide, zirconium oxide, zinc oxide, tin oxide, and transition metal oxide. Therefore, the fluorescent material may be effectively protected.

A second aspect of the present disclosure provides a preparation method of a fluorescent composite particle. The preparation method includes the following steps: preparing a fluorescent material precursor, and adding a surfactant to the fluorescent material precursor to obtain a first mixture; adding an oxide material precursor to the first mixture and allowing the oxide material precursor to undergo in-situ hydrolysis to obtain a second mixture, wherein a molar ratio of the fluorescent material precursor to the oxide material precursor is ranged from 10:1 to 1:50; and separating a solid mixture in the second mixture, calcining the solid mixture for a predetermined time under a predetermined temperature condition to obtain the fluorescent composite particle including an oxide material and a fluorescent material, wherein the fluorescent material is densely coated with the oxide material in the fluorescent composite particle, and the fluorescent composite particle has a particle size of 20 nm to 500 nm, a density of 1.8 g/cm³ to 7 g/cm³, and a specific surface area of 8 m²/g to 200 m²/g.

In the second aspect of the present disclosure, the oxide material precursor is added to the first mixture containing the fluorescent material precursor and subjected to in-situ hydrolysis, which may facilitate its uniform mixing with the fluorescent material precursor in the process of preparing the oxide material by hydrolysis; the particle size of the synthesized oxide material may be controlled by controlling a hydrolysis condition of the oxide material precursor, and a duct structure and pore size of the oxide material may be controlled by a surfactant, so as to control the overall morphology of the fluorescent composite particle; the oxide material in the solid mixture separated from the second mixture is approximately spherical with ordered mesopores (referred to as oxide microspheres), and the fluorescent material and/or the fluorescent material precursor are/is mixed together with the oxide microspheres and partially dispersed in mesopores of the oxide microspheres; the solid mixture is calcined for a predetermined time under a predetermined temperature condition, and a low temperature is selected as much as possible within a temperature range that allows the mesopores to melt; and during the calcination process, through a slow reaction, outer contours of the oxide microspheres may be maintained as much as possible to their original shapes, and the mesopores inside the oxide microspheres tend to melt and collapse to densely coat the fluorescent material located inside the ducts. Therefore, through the preparation method involved in the second aspect of the present disclosure, the morphology of the prepared fluorescent composite particle may be controlled (hereinafter referred to as a controllable morphology) to obtain the fluorescent composite particle with high stability and small particle size.

In the preparation method involved in the second aspect of the present disclosure, optionally, the surfactant includes one or more of an alkyl quaternary ammonium salt surfactant, a long-chain alkane epoxy ether, and a polyethylene oxide-polypropylene oxide block copolymer, and a molar ratio of the oxide material precursor to the surfactant is ranged from 0.5:1 to 50:1. In this case, the structure and size of a formed micelle may be adjusted by adding the surfactant, so that the structure and size of the mesopore ducts in the oxide microspheres may be adjusted to subsequently obtain the fluorescent composite particle with a predetermined morphology.

In the preparation method involved in the second aspect of the present disclosure, optionally, the predetermined temperature is ranged from 300° C. to 1200° C., and the predetermined time is ranged from 1 min to 600 min. In this case, the crystallization of the fluorescent material precursor in the ducts may be promoted to generate fluorescent nanocrystals, and the mesopore ducts in the oxide microspheres may be enabled to melt and collapse to densely coat the fluorescent nanocrystals.

In the preparation method involved in the second aspect of the present disclosure, optionally, the oxide material precursor includes one or more of a silicon-containing compound, an aluminum-containing compound, a titanium-containing compound, a zirconium-containing compound, a zinc-containing compound, a tin-containing compound, a nickel-containing compound, a lead-containing compound, a cobalt-containing compound, a cerium-containing compound, a chromium-containing compound and an indium-containing compound. Therefore, the fluorescent material may be effectively protected to improve the stability.

In the preparation method involved in the second aspect of the present disclosure, optionally, the fluorescent material precursor includes one or more of an AX precursor, a BX₂ precursor and a B′X₂ precursor, wherein A is Li, Na, K, Rb or Cs; B′ and B are different and each independently are Ge, Sn, Pb, Cu, Mn, Ca, Sr or Ba; and X is F, Cl, Br or I.

In the preparation method involved in the second aspect of the present disclosure, optionally, the fluorescent material precursor includes a cationic precursor and an anionic precursor in a molar ratio of 1:1; the cationic precursor is used to supply cationic D′, wherein i is an integer of 1-10; the cationic precursor is selected from oxides, nitrides, phosphides, sulfides, selenides, hydrochlorides, acetates, carbonates, sulfates, phosphates, nitrates and their hydrates of the following elements: Zn, Cd, Hg, Al, Ga and In; the anionic precursor is used to supply anionic Yⁿ⁻, wherein n is an integer of 1-10; and the anionic precursor is selected from elementary substances and inorganic salts of the following elements: S, Se, Te, N, P, As and Sb.

In the preparation method involved in the second aspect of the present disclosure, optionally, before the solid mixture is separated, an organic solvent is added to the second mixture first to terminate the hydrolysis reaction of the oxide material precursor, and then separated to obtain the solid mixture. In this case, by adding the organic solvent to the second mixture, the hydrolysis reaction of the oxide precursor may be terminated quickly and efficiently, which is conducive to the control of oxide size, and may also reduce the solubility of the fluorescent material and/or the fluorescent material precursor, thereby achieving the co-separation of the fluorescent material and/or the fluorescent material precursor, as well as the oxide material.

In the preparation method involved in the second aspect of the present disclosure, optionally, the organic solvent includes one or more of acetone, methanol, ethanol and tetrahydrofuran, and a volume ratio of the organic solvent to the second mixture is ranged from 1:1 to 10:1. Therefore, it is facilitated for the fluorescent material precursor to be separated from an original solvent, so as to achieve the co-separation of the fluorescent material and/or the fluorescent material precursor, as well as the oxide material.

In the preparation method involved in the second aspect of the present disclosure, optionally, the solid mixture in the second mixture is separated by means of segmented drying, wherein the segmented drying includes a primary evaporation and a secondary evaporation, and a drying temperature of the primary evaporation is lower than a drying temperature of the secondary evaporation. In this case, the solvent may be slowly volatilized at the time of the primary evaporation at a low temperature, the microphase separation may be induced by using slow volatilization of the solvent to form a composite liquid crystal phase (approximately in a gel state), and further cross-linking and curing treatment may be carried out at the time of the secondary evaporation at a high temperature, such that the oxide material may further form a rigid and uniform mesoscopic structure (i.e., a spherical shape with ordered mesopores), which is conducive to the dispersion of the fluorescent material and/or the fluorescent material precursor in the mesopores of the oxide microspheres.

In the preparation method involved in the second aspect of the present disclosure, optionally, the drying temperature of the primary evaporation is ranged from 30° C. to 50° C., and the evaporation time is ranged from 1 h to 30 h; and the drying temperature of the secondary evaporation is ranged from 60° C. to 90° C., and the evaporation time is ranged from 1 h to 20 h. In this case, the oxide microspheres with ordered mesopores may be formed easily.

A third aspect of the present disclosure provides a preparation method of a fluorescent composite particle. The preparation method includes the following steps: preparing a mixture including a fluorescent material precursor, an oxide material and a fluxing agent, wherein a molar ratio of the fluorescent material precursor to the oxide material is ranged from 10:1 to 1:100, the oxide material is oxide microspheres having ordered mesopores, and the fluxing agent is present in mesopore ducts of the oxide microspheres in the mixture; and
calcining the mixture for a predetermined time under a predetermined temperature condition to obtain the fluorescent composite particle including an oxide material and a fluorescent material, wherein the fluorescent material is densely coated with the oxide material in the fluorescent composite particle, and the fluorescent composite particle has a particle size of 20 nm to 500 nm, a density of 1.8 g/cm³ to 7 g/cm³, and a specific surface area of 8 m²/g to 200 m²/g.

In the third aspect of the present disclosure, the prepared mixture includes the fluorescent material precursor, the oxide material and the fluxing agent, wherein the oxide material is oxide microspheres with ordered mesopores, and the fluxing agent is present in the mesopore ducts of the oxide microspheres. When the mixture is calcined under the predetermined temperature condition, the fluorescent material precursor is heated to migrate into the ducts of the oxide microspheres, and is cooled to generate the fluorescent nanocrystals in the subsequent process. Internal ducts of the oxide microspheres where the fluxing agent is present are prone to melt and collapse under the action of the fluxing agent to coat the fluorescent nanocrystals located in the ducts, while the oxide microspheres do not melt on the outside (or only a small amount of oxide microspheres melt without affecting their overall morphology), which may reduce the adhesion between the particles and maintain the morphologies of the oxide microspheres while the fluorescent material is densely coated with the oxide microspheres. Therefore, through the preparation method involved in the third aspect of the present disclosure, the morphology of the prepared fluorescent composite particle may be controlled to obtain the fluorescent composite particle with high stability and small particle size.

In the preparation method involved in the third aspect of the present disclosure, optionally, before the mixture is calcined, the mixture is dissolved in a solvent to obtain a first mixture; the first mixture is dried to obtain a mixture powder; and then the mixture powder is calcined. In this case, the fluorescent material precursor and the fluxing agent may enter the ducts of the oxide microspheres easily and be distributed more uniformly, thereby facilitating the uniform growth of the fluorescent material inside the oxide microspheres during calcination and ensuring that the ducts collapse uniformly and densely. Therefore, the fluorescent property and stability of the fluorescent composite particle may be improved.

In the preparation method involved in the third aspect of the present disclosure, optionally, the fluorescent material precursor is present in the mesopore ducts of the oxide microspheres in the mixture. Therefore, the number of the nanocrystals inside the oxide microspheres may be increased, thereby improving the fluorescence intensity of the fluorescent composite particle.

In the preparation method involved in the third aspect of the present disclosure, optionally, the fluxing agent is a potassium salt, a sodium salt or a rubidium salt, and a molar ratio of the fluxing agent to the fluorescent material precursor is ranged from 0.1:1 to 2:1. Therefore, the mesopores of the oxide microspheres may be caused to melt and collapse at high temperatures.

In the preparation method involved in the third aspect of the present disclosure, optionally, the oxide microsphere has a particle size of 100 nm to 500 nm, and the mesopore of the oxide microspheres has a pore size of 2 nm to 10 nm. In this case, by selecting the oxide microspheres of this size, the composite particle of a predetermined size may be prepared easily, and the pore sizes of the mesopores may affect the sizes of the nanocrystals. Specifically, in the process of high-temperature calcination, the ducts are softened, and the fluorescent material precursor is continuously melted and vaporized to crystallize in the ducts; and some nanocrystals will break through the limit of pore sizes and grow up till the sizes are larger than the pore sizes of the ducts, while some nanocrystals will be smaller than the pore sizes of the pores. Therefore, the nanocrystals whose sizes are within a predetermined range may be obtained.

In the preparation method involved in the third aspect of the present disclosure, optionally, the predetermined temperature is ranged from 300° C. to 1200° C., and the predetermined time is ranged from 1 min to 600 min. In this case, the crystallization of the fluorescent material precursor in the ducts may be promoted to generate fluorescent nanocrystals, and the mesopore ducts in the oxide microspheres may be enabled to melt and collapse to densely coat the fluorescent nanocrystals.

According to the present disclosure, a fluorescent composite particle with strong stability and small particle size and two preparation methods that may obtain a fluorescent composite particle with a predetermined morphology may be provided.

### BRIEF DESCRIPTION OF THE DRAWINGS

Illustrative embodiments of the disclosure are described in detail below with reference to the attached drawing figures.

FIG. 1 shows a schematic diagram illustrating a composite particle involved in an example of the present disclosure.

FIG. 2 shows a flowchart illustrating a preparation method I involved in an example of the present disclosure.

FIG. 3 shows a schematic diagram illustrating oxide microspheres involved in an example of the present disclosure.

FIG. 4 shows a flowchart of a preparation method II involved in an example of the present disclosure.

FIG. 5 shows TEM and mapping diagrams illustrating a CsPbBr₃—SiO₂ composite particle in Embodiment 1 of the present disclosure.

FIG. 6 shows an optical photograph illustrating the CsPbBr₃—SiO₂ composite particle in Embodiment 1 of the present disclosure.

FIG. 7 shows an XRD diagram illustrating the CsPbBr₃—SiO₂ composite particle in Embodiment 1 of the present disclosure.

FIG. 8 shows a comparative diagram of fluorescence spectra of the CsPbBr₃—SiO₂ composite particle in Embodiment 1 of the present disclosure and a commercially available silicate green florescent powder.

FIG. 9 shows a variation diagram of fluorescence spectra of the CsPbBr₃—SiO₂ composite particle in Embodiment 1 of the present disclosure soaked in a hydrochloric acid solution for 0 day and 60 days.

FIG. 10 shows a schematic diagram illustrating a CsPbBr₃—SiO₂ composite particle in Embodiment 2 of the present disclosure.

FIG. 11 shows a TEM diagram illustrating a CsPbBr₃—SiO₂ composite particle in Embodiment 3 of the present disclosure.

FIG. 12 shows an optical photograph illustrating a CsPbBr₃—SiO₂ composite particle powder in Embodiment 4 of the present disclosure.

FIG. 13 shows TEM and mapping diagrams illustrating a CsPbBr_{1.5}I_{1.5}—SiO₂ composite particle in Embodiment 5 of the present disclosure.

FIG. 14 shows an optical photograph illustrating the CsPbBr_{1.5}I_{1.5}—SiO₂ composite particle in Embodiment 5 of the present disclosure.

FIG. 15 shows TEM and mapping diagrams illustrating a CsPbI₃—SiO₂ composite particle in Embodiment 6 of the present disclosure.

FIG. 16 shows an optical photograph illustrating a CsPbI₃—SiO₂ composite particle powder in Embodiment 6 of the present disclosure.

FIG. 17 shows a TEM diagram illustrating a CsPbBr₃—SiO₂ composite particle in Embodiment 7 of the present disclosure.

FIG. 18 shows an optical photograph illustrating a CsPbBr₃—SiO₂ composite particle in Embodiment 8 of the present disclosure.

FIG. 19 shows an optical photograph illustrating a CsPbBr₃—SiO₂ composite particle in Embodiment 9 of the present disclosure.

FIG. 20 shows a size distribution diagram illustrating a CsPbBr₃—SiO₂ composite particle in Embodiment 10 of the present disclosure which was measured by dynamic light scattering.

FIG. 21 shows a SEM diagram illustrating a CsPbBr₃—SiO₂ composite particle in Embodiment 11 of the present disclosure.

FIG. 22 shows a TEM diagram illustrating a CsPbBr₃—SiO₂ composite particle in Embodiment 12 of the present disclosure.

FIG. 23 shows a size distribution diagram of nanocrystals obtained based on the TEM diagram of FIG. 22.

FIG. 24 shows a TEM diagram illustrating a CsPbBr₃—SiO₂ composite particle in Embodiment 13 of the present disclosure.

FIG. 25 shows an optical photograph illustrating a CsPbBr₃—SiO₂ composite particle in Embodiment 14 of the present disclosure.

FIG. 26 shows a comparative diagram of fluorescence spectra of a CsPbBr₃—SiO₂ composite particle in Embodiment 15 of the present disclosure and the CsPbBr₃—SiO₂ composite particle in Embodiment 1.

FIG. 27 shows a comparative diagram of ultraviolet-visible absorption spectra of a CsPbBr₃@Cs₄PbBr₆—SiO₂ composite particle in Embodiment 16 of the present disclosure and the CsPbBr₃—SiO₂ composite particle in Embodiment 3.

FIG. 28 shows a TEM diagram illustrating a CsPbBr₃—SiO₂ fluorescent powder in Comparative example 2 of the present disclosure.

FIG. 29 shows a schematic diagram of the variations in the fluorescence intensity of composite particles in Embodiment 1 and Comparative example 1 over time which are impregnated in a hydrochloric acid solution.

FIG. 30 shows a comparative diagram of light attenuation of the CsPbBr₃—SiO₂ composite particle in Embodiment 1 of the present disclosure and CsPbBr₃ nanocrystals in Comparative example 3.

FIG. 31 shows a schematic diagram of nanocrystal ink in Embodiment 1 under natural light and ultraviolet light.

FIG. 32 shows a schematic diagram of nanocrystal ink in Comparative example 2 which is allowed to stand for 30 min under natural light and ultraviolet light.

FIG. 33 shows a schematic diagram illustrating a color transformation layer.

FIG. 34 shows a schematic diagram illustrating a patterned color transformation layer.

### DETAILED DESCRIPTION

The following describes some non-limiting exemplary embodiments of the invention with reference to the accompanying drawings. The described embodiments are merely a part rather than all of the embodiments of the invention. All other embodiments obtained by a person of ordinary skill in the art based on the embodiments of the disclosure shall fall within the scope of the disclosure.

Hereinafter preferred embodiments of the present disclosure will be described in detail with reference to the accompanying drawings. In the following description, the same reference numerals are assigned to the same components, and overlapping descriptions are omitted. In addition, the drawings are only schematic diagrams, and the ratio in dimensions of the components, the shapes of the components, and the like may be different from those of the actual ones.

A first aspect of the present disclosure relates to a fluorescent composite particle. The fluorescent composite particle involved in the present disclosure has strong stability, small particle size, and a good fluorescence effect. In the present disclosure, the fluorescent composite particle may be referred to as a “composite particle”, or may also be referred to as a nanocomposite particle, a composite fluorescent material, a composite fluorescent material, a composite luminescent material, etc. The composite particle involved in the first aspect of the present disclosure may be applied in any field that requires the use of a fluorescent material, such as a display field, a fluorescence imaging field, and a lighting field. For example, the composite particle of the present disclosure may be used as a raw material for the preparation of a color transformation layer, a raw material for the preparation of semiconductor nanocrystal ink, a raw material for the preparation of a bioimaging fluorescent probe, etc. Depending on different properties and structures of fluorescent materials, different types of fluorescent materials may exist, such as semiconductor fluorescent materials and non-semiconductor fluorescent materials. In the present disclosure, different types of fluorescent materials may be selected according to actual needs. The composite particle of the present disclosure may be named based on different types of fluorescent materials. For example, when the fluorescent material is a semiconductor material, the composite particle may be referred to as a semiconductor fluorescent composite particle.

The present disclosure further provides a preparation method of a plurality of fluorescent composite particles, which will be detailed later. Through the preparation method of the present disclosure, the morphology of the prepared fluorescent composite particle may be controlled to obtain the fluorescent composite particle with high stability and small particle size.

The fluorescent composite particle and the preparation method thereof involved in the present disclosure are described below in conjunction with the accompanying drawings.

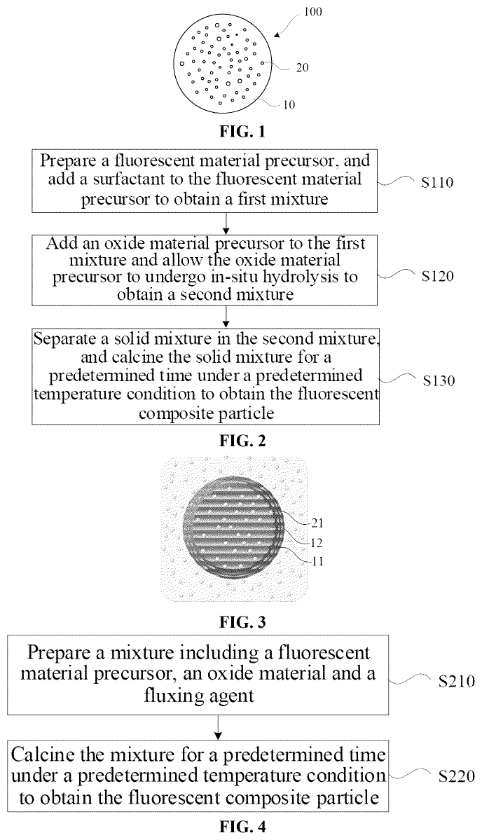

FIG. 1 is a schematic diagram illustrating a composite particle 100 involved in an example of the present disclosure.

In the composite particle 100 shown in FIG. 1, the fluorescent material may include a plurality of nanocrystals 20. The plurality of nanocrystals 20 may be dispersed in an oxide material 10.

In the present example, the composite particle may include a fluorescent material and the oxide material. Wherein the fluorescent material may include a plurality of fluorescent nanocrystals (in the present disclosure, the fluorescent nanocrystals may be later referred to as nanocrystals, or as quantum dots). The fluorescent material may be densely coated with the oxide material. In this case, the oxide material may play a good role in protecting the fluorescent material, reduce the influence of an external environment on the fluorescent material, and improve the overall stability. In some examples, the plurality of nanocrystals may be dispersed inside the oxide material. It should be noted that due to the synthesis process of the composite particle, the nanocrystals may also exist on the outer wall of the oxide material. For example, some nanocrystals may be embedded onto the outer wall of the oxide material. Since these nanocrystals located on the outer wall of the oxide material are exposed to the outside, the stability of this part of the nanocrystals is not strong. In the present disclosure, the influences of the nanocrystals located inside the oxide material on the overall optoelectronic properties and fluorescent characteristics of the composite particle are mainly considered.

In some examples, the composite particle may include a fluorescent material and an oxide material, the fluorescent material may be densely coated with the oxide material. Wherein the fluorescent material may be nanocrystalline. In other words, the fluorescent material may be composed of a plurality of fluorescent nanocrystals.

In some examples, the composite particle may have a particle size of 20 nm to 500 nm. For example, the composite particle may have a particle size of 20 nm, 30 nm, 40 nm, 50 nm, 60 nm, 80 nm, 90 nm, 100 nm, 120 nm, 150 nm, 180 nm, 200 nm, 230 nm, 250 nm, 280 nm, 300 nm, 320 nm, 350 nm, 360 nm, 380 nm, 400 nm, 420 nm, 450 nm, 460 nm, 480 nm, or 500 nm. It should be noted that the particle size of the composite particle may refer to a diameter of the composite particle. In this case, the small-size (nanoscale) composite particle may be easily processed in a solution (e.g., may be uniformly dispersed in the solution) and may further be applied in the fields of high-quality display, such as micro-LED and biological imaging. Specifically, in the field of biological imaging, the smaller the fluorescent composite particle, the easier the fluorescent composite particle is to enter cells; and in the display field, the quality of a color transformation film prepared by using the small-size composite particle as a raw material for the preparation of the color transformation film is better (more uniform), which may meet the needs of the imaging field.

In some examples, the composite particle may be spherical. That is, the oxide material may be in the form of a solid sphere, and the plurality of nanocrystals may be dispersed inside the oxide material. It should be noted that, from a microscopic point of view, the composite particle is not completely regular spherical, and such approximately spherical composite particle also falls within the scope of “spherical” mentioned in the present disclosure. In the present disclosure, the composite particle may also be referred to as a composite fluorescent microsphere or a composite fluorescent nanosphere, which refers to an approximately spherical small-size composite particle, and the designations of the microsphere and nanosphere do not imply a limit on the size of the composite particle.

In some examples, the composite particle may have a density of 1.8 g/cm³ to 7 g/cm³. For example, the composite particle may have a density of 1.8 g/cm³, 2 g/cm³, 2.2 g/cm³, 2.5 g/cm³, 2.8 g/cm³, 3 g/cm³, 3.5 g/cm³, 4 g/cm³, 4.5 g/cm³, 5 g/cm³, 5.5 g/cm³, 6 g/cm³, 6.5 g/cm³, 6.8 g/cm³, or 7 g/cm³. The density of the composite particle may be related to a texture of the oxide material. For example, when the oxide material is silicon oxide, the composite particle may have a density of 1.8 g/cm³ to 3 g/cm³; and when the oxide material is tin oxide, the composite particle may have a density of 6.5 g/cm³ to 7 g/cm³. In this case, the density of the composite particle may reflect a compact level of the oxide material to coat the fluorescent material. Compared with loose oxide shells, the dense coating of the fluorescent material with the oxide material in the present disclosure may help to improve the stability of the fluorescent material. In other words, the dense coating of the fluorescent material with the oxide material may improve the overall stability of the composite particle.

In some examples, the composite particle may have a specific surface area of 8 m²/g to 200 m²/g. For example, the composite particle may have a specific surface area of 8 m²/g, 10 m²/g, 20 m²/g, 30 m²/g, 50 m²/g, 60 m²/g, 80 m²/g, 100 m²/g, 110 m²/g, 120 m²/g, 140 m²/g, 150 m²/g, 160 m²/g, 170 m²/g, 180 m²/g or 200 m²/g. The specific surface area refers to a ratio of a total area (i.e., a sum of an inner surface area and an outer surface area) of the composite particle to the mass. For the same material, the smaller the particle volume, the greater the specific surface area. In the case that the particle size of the composite particle in the present disclosure is nanoscale, the denser an oxide, the smaller the exposed surface area. The specific surface area of the composite particle may reflect the compact level of the oxide material to coat the fluorescent material, and the composite particle with this specific surface area also has good photoelectric properties and fluorescent characteristics.

In some examples, a molar ratio of the fluorescent material to the oxide material may be 10:1 to 1:100. For example, the molar ratio of the fluorescent material to the oxide material may be 10:1, 5:1, 2:1, 1:1, 1:2, 1:5, 1:10, 1:20, 1:30, 1:40, 1:50, 1:60, 1:70, 1:80, 1:90, or 1:100. In this case, the oxide material may play a good role in protecting the fluorescent material. In addition, the photoelectric properties and fluorescent characteristics of the composite particle may be adjusted by adjusting the molar ratio of the fluorescent material to the oxide material. In some examples, optionally, the molar ratio of the fluorescent material to the oxide material may be 1:1 to 1:100.

In some examples, the plurality of nanocrystals may be uniformly dispersed inside the oxide material. Therefore, the oxide material may protect the nanocrystals and further improve the overall stability of the composite particle.

In some examples, each nanocrystal may have a particle size of 1 nm to 50 nm. For example, each nanocrystal may have a particle size of 1 nm, 2 nm, 3 nm, 4 nm, 5 nm, 6 nm, 7 nm, 8 nm, 9 nm, 10 nm, 12 nm, 13 nm, 15 nm, 16 nm, 18 nm, 20 nm, 22 nm, 24 nm, 25 nm, 26 nm, 28 nm, 30 nm, 32 nm, 34 nm, 35 nm, 36 nm, 38 nm, 40 nm, 42 nm, 45 nm, 48 nm, or 50 nm. In this case, the nanocrystals have good optoelectronic properties and fluorescent characteristics, which may make the composite particle have good overall photoelectric properties and fluorescent characteristic, as well as small overall particle size. In some examples, optionally, each nanocrystal may have a particle size of 5 nm to 30 nm.

In some examples, the nanocrystals may be spherical. It should be noted that, from a microscopic point of view, the nanocrystals are not completely regular spherical, and such approximately spherical nanocrystals also fall within the scope of “spherical” mentioned in the present disclosure.

In some examples, the plurality of nanocrystals may have different particle sizes under the restriction of a preparation process. In some examples, a difference between the particle sizes of any two nanocrystals in the plurality of nanocrystals is 0 nm to 25 nm. In other words, the difference between the particle sizes of any two nanocrystals in the plurality of nanocrystals may be not greater than 25 nm. In this case, the fluorescent characteristics of the plurality of nanocrystals are less different, which may make the composite particle have higher fluorescent color purity.

In some examples, the fluorescent material may have cations, and oxygen ions of the oxide material form bonds with the cations of the fluorescent material for lattice anchoring. Therefore, the oxide material may be easily combined with the fluorescent material, so as to further improve the stability of the composite particle. For example, when the nanocrystals are lead-halogen perovskite nanocrystals, there are Pb—O bonds between the oxide material and the nanocrystals, and the lattice anchoring is achieved through the Pb—O bonds, thereby further improving the stability between the nanocrystals and the oxide material.

In some examples, the fluorescent material may include nanocrystals with a perovskite structure. In other words, the nanocrystals may have a perovskite structure. In some examples, the perovskite structure may include ABX₃, A₄BX₆, and AB₂X₅. A is Li, Na, K, Rb or Cs, B is Ge, Sn, Pb, Cu, Mn, Ca, Sr or Ba, and X is F, Cl, Br or I. In some examples, optionally, the nanocrystals may have a perovskite structure ABX₃.

In some examples, the nanocrystals may be modified with a halide. In some examples, the halide may have a perovskite-type or non-perovskite-type structure. In some examples, the halide may have a structure of B′X₂, A′B′X₃, A′₄B′X₆ or A′B′₂X₅. A′ is Cs, Rb or K; B′ is Pb, Zn, Ca or Ba; and X is Cl, Br or I.

In some examples, optionally, the fluorescent material may include nanocrystals having a perovskite structure ABX₃ modified with the halide. A′ and A are each independently Cs, Rb or K; B′ and B are each independently Pb, Zn, Ca or Ba; X is Cl, Br or I, A′ and A may be the same or different; and B′ and B may be the same or different. In some examples, optionally, the fluorescent material may include nanocrystals having a perovskite structure ABX₃ modified with the halide B′X₂. A molar ratio of A to (B′+B) to X may be 1:1:3, and A is Cs, Rb or K; B′ and B are different and are each independently Pb, Zn, Ca or Ba; and X is Cl, Br or I. In some examples, in a scheme of nanocrystals having the perovskite structure ABX₃ modified with the halide B′X₂, a molar ratio of B′ to B in (B′+B) may be 1:1.

In some examples, the fluorescent material may include nanocrystals having a multiple structure. In some examples, the fluorescent material may include nanocrystals having a binary structure Dⁿ⁺Yⁿ⁻. In other words, the nanocrystals may have a binary structure Dⁿ⁺Yⁿ⁻. n is an integer of 1-10, a molar ratio of elements D to Y is 1:1, and D is Zn, Cd, Hg, Al, Ga or In; and Y is S, Se, Te, N, P, As or Sb. For another example, in some examples, the fluorescent material may include nanocrystals having a ternary structure. In other words, the nanocrystals may have a ternary structure. In some examples, the nanocrystals may have an IB-IIIA-VIA family ternary compound structure G⁺M³⁺(N²⁻)₂, wherein G⁺ is Cu⁺ or Ag⁺; M³ is In³⁺, Ga³⁺ or Al³⁺; N²⁻ is S²⁻ or Se²⁻; and a molar ratio of G⁺ to M³⁺ to N²⁻ may be 0.5:0.5:1.

It should be noted that the structure of the nanocrystals mainly affects the photoelectric properties and fluorescent characteristics of the composite particle, and nanocrystal structures that are not exhaustively listed in the specification also fall within the protection scope of the present disclosure. In the present disclosure, the dense coating of the nanocrystals with the oxide material may make the composite particle have strong stability, and also make the composite particle have small size and relatively regular morphology. That is, in the present disclosure, the oxide material may protect the nanocrystals of different structures.

In some examples, the nanocrystals in the fluorescent material may have the same structure. However, it should be noted that in the actual preparation process, even if the expectation is to prepare the nanocrystals with a certain structure, due to the uncontrollability of a microstructure reaction, some nanocrystals with other structures may still be produced. For example, it is expected to prepare fluorescent nanocrystals with a perovskite structure ABX₃, but some nanocrystals with structures A₄BX₆ and AB₂X₅ may still be produced during preparation. Therefore, even if some impurities are present, most of the nanocrystals still have the same structure, which still belongs to a scheme of the nanocrystals with the same structure described in the present disclosure.

In some examples, the fluorescent material may also include nanocrystals having different structures. For example, the fluorescent material may include nanocrystals with a perovskite structure ABX₃ and nanocrystals with perovskite structures A₄BX₆ and AB₂X₅ at the same time. Therefore, the composition and structure of the nanocrystals may be configured according to actual needs, so that the composite particle may be adapted to more application scenarios. In some examples, the nanocrystals in the fluorescent material may be the same substances having the same structure or different substances.

In some examples, the oxide material may be selected from any one of silicon oxide, aluminum oxide, titanium oxide, zirconium oxide, zinc oxide, tin oxide, and transition metal oxide. Therefore, the fluorescent material may be effectively protected.

According to the first aspect of the present disclosure, a composite particle having small particle size and strong stability may be provided.

As described above, a second aspect of the present disclosure relates to a preparation method (hereinafter referred to as a preparation method I) of a fluorescent composite particle.

FIG. 2 is a flowchart illustrating a preparation method I involved in an example of the present disclosure.

In the present embodiment, the preparation method I may include: preparing a fluorescent material precursor, and adding a surfactant to the fluorescent material precursor to obtain a first mixture (step S110); adding an oxide material precursor to the first mixture and allowing the oxide material precursor to undergo in-situ hydrolysis to obtain a second mixture (step S120); and separating a solid mixture in the second mixture, and calcining the solid mixture for a predetermined time under a predetermined temperature condition to obtain the fluorescent composite particle (step S130) (see FIG. 2). In the present disclosure, the oxide material precursor may be referred to simply as “oxide precursor”.

In the second aspect of the present disclosure, the oxide material precursor is added to the first mixture containing the fluorescent material precursor and subjected to in-situ hydrolysis, which may facilitate its uniform mixing with the fluorescent material precursor; the particle size of the synthesized oxide material may be controlled by controlling a hydrolysis condition of the oxide material precursor, and a duct structure and pore size of the oxide material may be controlled by a surfactant (described later), so as to control the overall morphology of the composite particle; the oxide material in the solid mixture separated from the second mixture is approximately spherical with ordered mesopores (referred to as oxide microspheres), and the fluorescent material and/or the fluorescent material precursor are/is mixed with the oxide microspheres together and partially dispersed in mesopores of the oxide microspheres; the solid mixture is calcined for a predetermined time under a predetermined temperature condition, and a low temperature is selected as much as possible within a temperature range that allows the mesopores to collapse; and during the calcination process, through a slow reaction, outer contours of the oxide microspheres may be maintained as much as possible to their original shapes, and the mesopores inside the oxide microspheres tend to melt and collapse to densely coat the fluorescent material located inside the ducts. Therefore, through the preparation method involved in the second aspect of the present disclosure, the morphology of the prepared composite particle may be controlled (hereinafter referred to as a controllable morphology) to obtain the composite particle with high stability and small particle size.

In some examples, the composite particle prepared by the preparation method I of the present disclosure may be identical with the composite particle involved in the first aspect of the present disclosure, and relevant parameters, components and proportions of the composite particle may be referred to the description of the composite particle involved in the first aspect of the present disclosure, and shall not be repeated herein. Of course, it should be understood that by adjusting the preparation parameters, a material that is not identical with the composite particle involved in the first aspect of the present disclosure may also be synthesized.

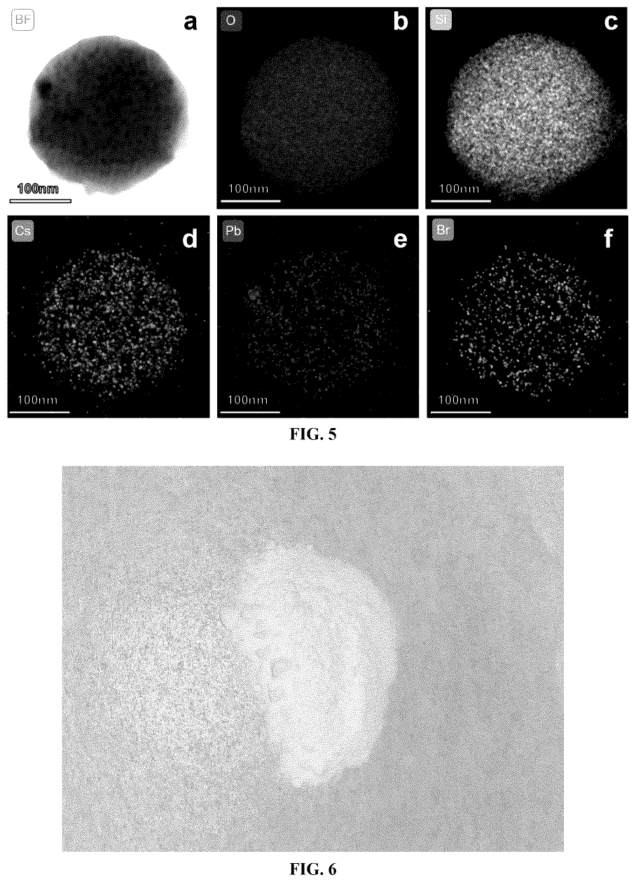

FIG. 3 is a schematic diagram illustrating oxide microspheres 11 involved in an example of the present disclosure.

In the example shown in FIG. 3, an internal structure of the oxide microspheres 11 is illustrated schematically. As shown in FIG. 3, the oxide microspheres 11 may have ordered mesopores 12, wherein a fluorescent material and/or fluorescent material precursor 21 may be partially dispersed in the mesopores 12 of the oxide microspheres 11, and partially located outside the oxide microspheres 11. In the course of calcination, the fluorescent material precursor 21 located in the mesopores may be melted and vaporized under the action of high temperature or migrated by heating, and crystallized in the ducts when cooled. The part of the fluorescent material precursor 21 located outside may be melted and vaporized under the action of high temperature or migrated by heating into the ducts of the oxide microspheres, and crystallized when cooled in the subsequent process, and the ducts of the mesopores 12 melt and collapse under the action of high temperature to densely coat the fluorescent material located in the ducts.

In some examples, each oxide microsphere may have a particle size of 20 nm to 500 nm. For example, each oxide microsphere may have a particle size of 20 nm, 30 nm, 40 nm, 50 nm, 60 nm, 80 nm, 90 nm, 100 nm, 120 nm, 150 nm, 180 nm, 200 nm, 230 nm, 250 nm, 280 nm, 300 nm, 320 nm, 350 nm, 360 nm, 380 nm, 400 nm, 420 nm, 450 nm, 460 nm, 480 nm, or 500 nm. In this case, by selecting the oxide microspheres having a predetermined size, the composite particle having a predetermined size may be prepared easily.

In some examples, each mesopore of the oxide microspheres may have a pore size of 2 nm to 10 nm. For example, each mesopore of the oxide microspheres may have a pore size of 2 nm, 3 nm, 4 nm, 5 nm, 6 nm, 7 nm, 8 nm, 9 nm, or 10 nm. The pore sizes of the mesopores may affect the sizes of the nanocrystals. Specifically, in the process of high-temperature calcination, the ducts are softened, and the fluorescent material precursor is continuously melted and vaporized to crystallize in the ducts; and some nanocrystals will break through the limit of pore sizes and grow up till the sizes are larger than the pore sizes of the ducts, while some nanocrystals will be smaller than the pore sizes of the ducts. In this case, by selecting the oxide microspheres with an appropriate pore size of the mesopores, the nanocrystals that are within a predetermined range may be obtained easily.

In some examples, in step S110, the fluorescent material precursor may be selected based on the fluorescent material to be synthesized. Therefore, the predetermined fluorescent material may be synthesized.

In some examples, the fluorescent material precursor may include one or more precursors. For example, the fluorescent material precursor may include one or more of an AX precursor, a BX₂ precursor and a B′X₂ precursor, wherein A is Li, Na, K, Rb or Cs; B′ and B are different and each independently Ge, Sn, Pb, Cu, Mn, Ca, Sr or Ba; and X is F, Cl, Br or I. Therefore, the nanocrystals with a perovskite structure may be prepared.

In some examples, in step S110, the fluorescent material precursor may include an AX precursor and a BX₂ precursor. A molar ratio of the AX precursor to the BX₂ precursor is 1:1. In some examples, in step S110, the fluorescent material precursor may include an AX precursor, a BX₂ precursor and a B′X₂ precursor. A molar ratio of the AX precursor to (the BX₂ precursor+the B′X₂ precursor) is 1:1. Therefore, the nanocrystals with a perovskite structure may be prepared.

In some examples, in step S110, the fluorescent material precursor may include a cationic precursor and an anionic precursor. The cationic precursor may be used to supply cation Dⁱ⁺, wherein i is an integer of 1-10; and the anionic precursor is used to supply anion Yⁿ⁻, wherein n is an integer of 1-10. In some examples, a molar ratio of the cationic precursor to the anionic precursor may be 1:1. Therefore, the nanocrystals with a binary structure Dⁿ⁺Yⁿ⁻ may be prepared.

In some examples, the cationic precursor may be selected from oxides, nitrides, phosphides, sulfides, selenides, hydrochlorides, acetates, carbonates, sulfates, phosphates, nitrates, and their hydrates from the following elements. In some examples, the anionic precursor may be selected from elementary substances and inorganic salts of the following elements: S, Se, Te, N, P, As, and Sb.

In some examples, the fluorescent material precursor may include three different precursors: a first precursor used to supply cations having a valence of +1, a second precursor used to supply cations having a valence of +3, and a third precursor used to supply anions having a valence of −2. The first precursor may be an IB family metal compound, and is selected from CuCl, CuBr, CuI, AgCl, AgBr, AgI and combinations thereof. The second precursor may be an IIIA family metal organic salt and is selected from formates, acetates and propionates of the following metals: In, Ga and Al. The third precursor may be inorganic salts of VIA family elements, and is selected inorganic salts of S and inorganic salts of Se. In addition, a molar ratio of the first precursor to the second precursor to the third precursor may be 0.5:0.5:1. Therefore, the nanocrystals with an IB-IIIA-VIA family ternary compound structure G⁺M³⁺(N²⁻)₂ may be prepared.

In some examples, in step S110, the surfactant may include one or more of an alkyl quaternary ammonium surfactant, a long-chain alkane epoxy ether (CₙH₂ₙ₊₁(CH₂CH₂O)ₘH, n and m being positive integers), and a polyethylene oxide-polypropylene oxide block copolymer. In this case, the size of a formed micelle may be adjusted by changing the surfactant, so that the size of the mesopore ducts in the oxide microspheres may be adjusted to subsequently obtain the composite particle with a predetermined morphology.

In some examples, in step S110, a molar ratio of the surfactant to the fluorescent material precursor may be 0.1:1 to 100:1. For example, the molar ratio of the surfactant to the fluorescent material precursor may be 0.1:1, 0.5:1, 1:1, 2:1, 5:1, 10:1, 15:1, 20:1, 25:1, 30:1, 40:1, 50:1, 60:1, 70:1, 75:1, 80:1, 85:1, 90:1, 95:1, or 100:1.

In some examples, in step S110, the surfactant may have a concentration of 0.2 mg/mL to 20 mg/mL. In this case, the surfactant has a concentration higher than a critical micelle concentration and may facilitate the formation of a micelle with an approximately regular morphology, for example, the formation of an approximately columnar micelle. At this time, in the process of hydrolysis to form the oxide material, the presence of the relatively regular micelle facilitates the formation of oxide microspheres with ordered mesopores.

In some examples, in step S120, a molar ratio of the fluorescent material precursor to the oxide precursor may be 10:1 to 1:50. For example, the molar ratio of the fluorescent material precursor to the oxide precursor may be 10:1, 5:1, 2:1, 1:1, 1:2, 1:5, 1:10, 1:15, 1:20, 1:25, 1:30, 1:35, 1:40, 1:45, or 1:50. In this case, the oxide material may play a good role in protecting the fluorescent material. In addition, the photoelectric properties and fluorescent characteristics of the composite particle may be adjusted by adjusting the molar ratio of the fluorescent material to the oxide material. In some examples, optionally, a molar ratio of the fluorescent material precursor to the oxide precursor may be 1:2 to 1:50.

In some examples, the surfactant may have a predetermined ratio to the oxide precursor. A molar ratio of the oxide precursor to the surfactant may be 0.5:1 to 50:1. For example, the molar ratio of the oxide precursor to the surfactant may be 0.5:1, 1:1, 1.5:1, 2:1, 3:1, 4:1, 5:1, 8:1, 10:1, 12:1, 15:1, 16:1, 18:1, 20:1, 22:1, 25:1, 30:1, 35:1, 40:1, 45:1, 48:1, or 50:1. Therefore, the sizes of ducts of the mesopores in the oxide microspheres may be adjusted easily through the surfactant.

In some examples, in step S120, the oxide material precursor may include one or more of a silicon-containing compound, an aluminum-containing compound, a titanium-containing compound, a zirconium-containing compound, a zinc-containing compound, a tin-containing compound, a nickel-containing compound, a lead-containing compound, a cobalt-containing compound, a cerium-containing compound, a chromium-containing compound and an indium-containing compound. The silicone-containing compound may be selected from one or more of tetramethyl silicate, tetraethyl silicate, tetrapropyl titanate, and tetrabutyl titanate. The aluminum-containing compound may be selected from one or more of aluminium triethanolate, aluminium isopropoxide, aluminium sec-butoxide, aluminium tert-butoxide, aluminium chloride, aluminium nitrate, and sodium metaaluminate. The titanium-containing compound may be selected from one or more of titanium isopropoxide, tetramethyl titanate, tetraethyl titanate, isopropyl titanate, tetrabutyl titanate, and titanium tetrachloride. The zirconium-containing compound may be selected from one or more of zirconium isopropoxide, zirconium 2-ethylhexanoate, zirconium chloride, zirconium oxychloride, zirconium sulfate, and zirconium sulfate. The zinc-containing compound may be selected from one or more of zinc acetate and zinc nitrate. The tin-containing compound may be selected from one or more of tin acetate, tin isopropoxide, sodium stannate, and tin chloride. The nickel-containing compound may be selected from one or more of nickel acetate, nickel carbonate, nickel sulfate, nickel halide, and nickel nitrate. The lead-containing compound may be selected from one or more of lead citrate, lead acetate, lead carbonate, lead sulfate, and lead nitrate. The cobalt-containing compound may be selected from one or more of cobalt halide, cobalt oxalate, cobalt carbonate, and cobalt sulfate. The cerium-containing compound may be selected from one or more of cerium nitrate, cerium sulfate, cerium oxalate, cerium acetate, cerium carbonate, and cerium phosphate. The chromium-containing compound may be selected from one or more of chromate and chromium halide. The indium-containing compound may be selected from one or more of indium acetate, indium halide, indium sulfate, and indium nitrate.

In some examples, in step S120, a catalyst may be added to improve the efficiency of the oxide precursor that undergoes in-situ hydrolysis to synthesize the oxide material. In some examples, the catalyst may be selected from one or more of ammonia water, tert-butylamine, sodium hydroxide, potassium hydroxide, barium hydroxide, and sodium hydroxide.

In some examples, in step S120, a molar ratio of the oxide precursor to the catalyst may be 0.5:1 to 50:1. For example, the molar ratio of the oxide precursor to the catalyst may be 0.5:1, 1:1, 10:1, 20:1, 30:1, 40:1, or 50:1. In this case, the in-situ hydrolysis of the oxide precursor may be promoted easily, and the speed of the hydrolysis reaction may be controlled by adjusting the ratio of the oxide precursor to the catalyst, thereby adjusting the sizes of the oxide microspheres. For example, within the range of 0.5:1 to 50:1, the smaller the molar ratio of the oxide precursor to the catalyst, the faster the hydrolysis reaction and the larger the particles of the synthesized oxide microspheres within the same time.

In some examples, in steps S110 and S120, the catalyst may be added to the first mixture together with the oxide precursor or to the first mixture prior to the oxide precursor. In this case, when the oxide precursor is added, the catalyst may immediately take effect to promote the in-situ hydrolysis of the oxide precursor.

In some examples, in steps S110 and S120, the surfactant, the fluorescent material precursor and the catalyst are mixed in no specific order, and in the event of adding various components, the components may also be mixed uniformly by means of stirring or shaking, etc. For example, in some examples, in steps S110 and S120, the surfactant may be mixed with the catalyst and then added with the fluorescent material precursor and the oxide precursor.

In some examples, the solid mixture may be separated from the second mixture after a predetermined time has elapsed since the hydrolysis reaction has occurred. Therefore, this may be conducive to the synthesis of the oxide material with sufficient quality and a regular morphology, and also conducive to uniform mixing of the fluorescent material precursor and the oxide material. In some examples, the predetermined time may be 1 min to 2000 min. For example, the predetermined time may be 1 min, 30 min, 60 min, 90 min, 150 min, 200 min . . . , or 2000 min.

In some examples, the oxide material and the fluorescent material precursor may be mixed in a liquid-phase environment. Therefore, it is facilitated for the fluorescent material precursor to easily enter internal ducts of the oxide microspheres and to be uniformly distributed with the oxide microspheres, and the fluorescent material precursor may generate fluorescent nanocrystals more uniformly in the internal ducts during calcination and cooling, so that the formed composite particle has stronger fluorescence intensity and better fluorescent color purity.

In some examples, as described above, in step S130, the solid mixture may be separated from the second mixture.

In some examples, in step S130, before the solid mixture is separated, an organic solvent is added to the second mixture first to terminate the hydrolysis reaction of the oxide material precursor. In this case, by adding the organic solvent to the second mixture, the hydrolysis reaction may be terminated quickly and efficiently, which is conducive to the control of oxide size, and may also reduce the solubility of the fluorescent material and/or the fluorescent material precursor, thereby achieving the co-separation of the fluorescent material and/or the fluorescent material precursor, as well as the oxide material. That is, the oxide size may be controlled by adding an anti-solvent, and the co-separation of the fluorescent material and/or fluorescent material precursor as well as the oxide material may be achieved.

In some examples, the organic solvent may include one or more of acetone, methanol, ethanol, and tetrahydrofuran. Therefore, the effects of terminating the hydrolysis reaction and reducing the solubility may be achieved. In some examples, a volume ratio of the organic solvent to the second mixture may be 1:1 to 10:1. For example, the volume ratio of the organic solvent to the second mixture may be 1:1, 2:1, 3:1, 4:1, 5:1, 6:1, 7:1, 8:1, 9:1, or 10:1. In this case, it is facilitated for the fluorescent material precursor to be separated from the original solvent, so as to achieve the co-separation of the fluorescent material and/or the fluorescent material precursor, as well as the oxide material.

In some examples, in step S130, the solid mixture may be separated by means of centrifugation, filtration, and/or drying, etc. For example, the solid mixture may be obtained by removing a supernatant after centrifugation.

In some examples, the solid mixture in the second mixture may be separated by means of segmented drying. Specifically, the segmented drying includes primary evaporation and secondary evaporation, and a drying temperature of the primary evaporation is lower than a drying temperature of the secondary evaporation. In this case, the solvent may be slowly volatilized at the time of the primary evaporation at a low temperature, the microphase separation may be induced by using slow volatilization of the solvent to form a composite liquid crystal phase (approximately in a gel state), and further cross-linking and curing treatment may be carried out at the time of the secondary evaporation at a high temperature, such that the oxide material may further form a rigid and uniform mesoscopic structure (i.e., a spherical shape with ordered mesopores), which is conducive to the dispersion of the fluorescent material and/or the fluorescent material precursor in the mesopores of the oxide microspheres.

In some examples, in step S230, the drying temperature of the primary evaporation may be 30° C. to 50° C. For example, the drying temperature of the primary evaporation may be 30° C., 35° C., 40° C., 45° C., or 50° C. In some examples, the evaporation time of the primary evaporation may be 1 h to 30 h. For example, the evaporation time of the primary evaporation may be 1 h, 2 h, 3 h, 4 h, 5 h, 6 h, 8 h, 10 h, 15 h, 20 h, 25 h, or 30 h. During the primary evaporation, when the second mixture transforms into milky white translucent gel, it means that the solvent volatilization is over at this time, the composite liquid crystal phase is formed, and the temperature may be adjusted to the drying temperature of the secondary evaporation for secondary evaporation to enter the next procedure. In some examples, optionally, the evaporation time of the primary evaporation may be 5 h to 30 h.

In some examples, in step S230, the drying temperature of the secondary evaporation may be 60° C. to 90° C. For example, the drying temperature of the secondary evaporation may be 60° C., 65° C., 70° C., 75° C., 80° C., 85° C., or 90° C. In some examples, the evaporation time of the secondary evaporation may be 1 h to 20 h. For example, the evaporation time of the secondary evaporation may be 1 h, 2 h, 3 h, 4 h, 5 h, 6 h, 8 h, 10 h, 15 h, or 20 h. When a sample is observed to be a white powder during the secondary evaporation, it means that the sample has been completely dried and a rigid and uniform mesoscopic structure has been formed; and at this time, the evaporation may be terminated and the mixture powder may be obtained. In some examples, in step S130, after the solid mixture is separated from the second mixture, the solid mixture may be dried to obtain a dry solid powder for calcination. In some examples, optionally, the drying temperature of the secondary evaporation may be 70° C. to 90° C., and the evaporation time of the secondary evaporation may be 1 h to 20 h.

In some examples, in step S130, the solid mixture and a fluxing agent may be mixed uniformly and then calcined. Since the mesoporous oxide microspheres account for the majority of the specific surface area of the ducts, most of the fluxing agent will be distributed within the ducts. In this case, internal ducts of the oxide microspheres where the fluxing agent is present are prone to melt and collapse under the action of the fluxing agent to coat the fluorescent nanocrystals located in the ducts, while the oxide microspheres do not melt on the outside (or only a small amount of oxide microspheres melt without affecting their overall morphology), which may reduce the adhesion between the particles and maintain the morphologies of the oxide microspheres while the fluorescent material is densely coated with the oxide microspheres. Therefore, the morphology of the composite particle may be adjusted easily. That is, by adding the fluxing agent into the oxide microspheres, selective sintering may be carried out during calcination, so that the outer contours of the oxide microspheres remain approximately unchanged, while the internal mesopores melt and collapse under the action of the fluxing agent. Moreover, the addition of the fluxing agent may also reduce the required sintering temperature and time, thereby further reducing the adhesion between the particles.

In some examples, the chance of adding the fluxing agent is not limited. For example, the fluxing agent may be added before or after the solid mixture is separated from the second mixture. For example, in an example where the organic solvent is used, the fluxing agent may be added before and after the addition of the organic solvent. The fluxing agent being added before separation may facilitate more fluxing agent to enter the ducts of the oxide microspheres, which is conducive to the melting and collapse of the internal mesopores of the oxide microspheres during subsequent calcination.

In some examples, the fluxing agent may be a salt compound. In some examples, the fluxing agent may be a potassium salt. For example, the fluxing agent may include one or more of potassium carbonate, potassium chloride, potassium bromide, potassium iodide, potassium fluoride, potassium hydroxide, and potassium sulfate. Therefore, the mesopores of the oxide microspheres may be caused to melt and collapse at high temperatures. In some examples, the fluxing agent may be a sodium salt. For example, the fluxing agent may include one or more of sodium carbonate, sodium chloride, sodium bromide, sodium iodide, sodium fluoride, sodium hydroxide, and sodium sulfate. Therefore, the mesopores of the oxide microspheres may be caused to melt and collapse at high temperatures. In some examples, the fluxing agent may be a rubidium salt. For example, the fluxing agent may include one or more of rubidium carbonate, rubidium chloride, rubidium bromide, rubidium iodide, rubidium fluoride, rubidium hydroxide, and rubidium sulfate. Therefore, the mesopores of the oxide microspheres may be caused to melt and collapse at high temperatures.

In some examples, a molar ratio of the fluxing agent to the fluorescent material precursor may be 0.1:1 to 2:1. For example, the molar ratio of the fluxing agent to the fluorescent material precursor may be 0.1:1, 0.2:1, 0.3:1, 0.4:1, 0.5:1, 0.8:1, 1:1, 1.2:1, 1.5:1, 1.8:1, or 2:1. Therefore, the mesopores of the oxide microspheres may be caused to melt and collapse at high temperatures. In the course of setting the molar ratio of the fluxing agent to the fluorescent material precursor, the molar amount of the fluxing agent is calculated as its host element. For example, in an example where the fluxing agent is the potassium salt, the molar amount of the fluxing agent is calculated in K.

In some examples, in step S130, the predetermined calcination temperature may be 300° C. to 1200° C. For example, the predetermined calcination temperature may be 300° C., 400° C., 500° C., 600° C., 700° C., 800° C., 900° C., 1000° C., 1100° C., or 1200° C. In some examples, in step S130, the predetermined calcination time may be 1 min to 600 min. For example, the predetermined calcination time may be 1 min, 30 min, 60 min, 120 min, 180 min, 240 min, 300 min, 360 min, 400 min, 420 min, 480 min, 500 min, 540 min, or 600 min. The predetermined temperature is related to the type of the oxide precursor. Specifically, the predetermined temperature is not lower than a collapse temperature of the mesopore ducts in the oxide microspheres. For example, when the oxide precursor is a silicon-based oxide, the predetermined temperature may be 400° C. to 700° C. Therefore, the mesopore ducts in the oxide microspheres may melt and collapse by calcination so as to coat the fluorescent material.

In some examples, in step S130, the temperature may be selected as low as possible within a temperature range that may melt the mesopores of the oxide microspheres, and the calcination time may be maintained for a long time, so that the outer contours of the oxide microspheres may maintain the original morphology as much as possible through a slow reaction during the calcination process, and the mesopores inside the oxide microspheres will melt and collapse to densely coat the fluorescent material located in the ducts. For example, when the oxide material is a silicon-based oxide, the silicon-based oxide may melt to varying degrees within a calcination temperature range of 400° C. to 700° C. In this case, selecting the temperature as low as possible within this temperature range means that a calcination temperature of 400° C. to 600° C., for example, may be selected for calcination, and the calcination time of more than 30 min may be maintained. In this case, the silicon-based oxide microspheres melt slowly and steadily during calcination, the outer contours basically maintain the original morphology after calcination, and the adhesion between the microspheres is less negligible; and the ducts of the internal mesopores have melted and collapsed to coat nanocrystals.

In some examples, optionally, when the oxide material is a silicon-based oxide, the calcination temperature may be 500° C. to 600° C. In this case, the oxide microspheres may melt slowly and steadily to maintain the external morphology and reduce the adhesion, and the ducts may collapse completely, thereby achieving dense coating of the nanocrystals with the oxide.

In some examples, in step S130, the predetermined temperature and the predetermined time are negatively correlated within a certain range. That is, within a certain range, the higher the predetermined temperature during calcination, the shorter the predetermined time. Therefore, a composite particle with a predetermined morphology may be prepared easily.

In some examples, in step S130, the solid mixture may be calcined in a high-temperature furnace. The temperature in the high-temperature furnace may be raised to a predetermined temperature at a temperature rise rate of 1° C./min to 20° C./min. In this case, the temperature in the high-temperature furnace rises slowly, which may facilitate uniform heating of the solid mixture in this process, thereby further improving the stability of the prepared composite particle.

In some examples, in step S130, after the calcination is completed, the product may be ground and washed. Specifically, the product may be ground; the ground product is washed in water; a supernatant is removed by centrifugation; the washing and centrifugation operations are repeated; and a precipitate obtained after multiple centrifugation is finally dried to obtain the composite particle. Therefore, instable nanocrystals and/or precursor on the product surface may be removed.

In summary, through the preparation method I involved in the second aspect of the present disclosure, the fluorescent composite particle with the predetermined morphology may be prepared, and the prepared composite particle has strong stability, small particle size, as well as good photoelectric properties and fluorescent characteristics.

As described above, a third aspect of the present disclosure relates to a preparation method (hereinafter referred to as a preparation method II) of a fluorescent composite particle.

FIG. 4 is a flowchart of a preparation method II involved in an example of the present disclosure.

In the present embodiment, the preparation method II may include: preparing a mixture including a fluorescent material precursor, an oxide material and a fluxing agent (step S210); and calcining the mixture for a predetermined time under a predetermined temperature condition to obtain the fluorescent composite particle (step S220). In step S210, the added oxide material is oxide microspheres with ordered mesopores, and the mixing order of the fluorescent material precursor, the oxide material and the fluxing agent is not limited. For example, the oxide material may be mixed with the fluxing agent first such that the mesopore ducts of the oxide microspheres contain the fluxing agent, and then added with the fluorescent material precursor for mixing; or the fluorescent material precursor may be mixed with the oxide material first, and then added with the fluxing agent for mixing; or the fluorescent material precursor, the oxide material and the fluxing agent may be mixed at the same time.

In this case, the prepared mixture includes the fluorescent material precursor, the oxide material and the fluxing agent, wherein the oxide material is oxide microspheres with ordered mesopores, and the fluxing agent is present in the mesopore ducts of the oxide microspheres. When the mixture is calcined under a predetermined temperature condition, the fluorescent material precursor is heated to migrate into the ducts of the oxide microspheres, and is cooled to generate the fluorescent nanocrystals in the subsequent process. Internal ducts of the oxide microspheres where the fluxing agent is present are prone to melt and collapse under the action of the fluxing agent to coat the fluorescent nanocrystals located in the ducts, while the oxide microspheres do not melt on the outside (or only a small amount of oxide microspheres melt without affecting their overall morphology), which may reduce the adhesion between the particles and maintain the morphologies of the oxide microspheres while the fluorescent material is densely coated with the oxide microspheres. Therefore, through the preparation method II involved in the third aspect of the present disclosure, the morphology of the prepared composite particle may be controlled to obtain the composite particle with high stability and small particle size.

That is, in the preparation method II involved in the third aspect of the present disclosure, by adding the fluxing agent into the oxide microspheres, selective sintering may be carried out during calcination, so that the outer contours of the oxide microspheres remain approximately unchanged, while the internal mesopores tend to melt and collapse under the action of the fluxing agent, such that the fluorescent material may be densely coated with the oxide microspheres while the morphologies of the oxide microspheres are maintained, thereby obtaining the composite particle with a predetermined morphology, high stability and small particle size. Moreover, the addition of the fluxing agent may also reduce the required sintering temperature and time, thereby further reducing the adhesion between the particles.

Moreover, the composite particle prepared by the preparation method II of the present disclosure may be identical with the composite particle involved in the first aspect of the present disclosure, and relevant parameters, components and proportions of the composite particle may be referred to the description of the composite particle involved in the first aspect of the present disclosure, and shall not be repeated herein. Of course, it should be understood that by adjusting the preparation parameters, a material that is not identical with the composite particle involved in the first aspect of the present disclosure may also be synthesized. For example, when a composite particle with large particle size but regular morphology needs to be synthesized, oxide microspheres with large particle sizes may be selected.

In some examples, the fluorescent material precursor may be selected based on the fluorescent material to be synthesized. Therefore, the predetermined fluorescent material may be synthesized. The specific fluorescent material precursor may refer to the fluorescent material precursor described in the second aspect of the present disclosure, and will not be repeated here.

In some examples, in step S210, the oxide material and the fluorescent material precursor may be mixed in a liquid-phase environment. Therefore, the fluorescent material precursor may easily enter internal ducts of the oxide microspheres, and the fluorescent material precursor located inside the ducts during calcination may generate more fluorescent nanocrystals, so that the formed composite particle has stronger fluorescence intensity.

In some examples, in step S210, the mixture may be dissolved in the first solvent to obtain the first mixture; the first mixture is then dried to obtain a mixture powder; and the mixture powder is calcined. In other words, the fluorescent material precursor, the oxide material and the fluxing agent may be added to the first solvent to form the first mixture. In this case, the fluorescent material precursor and the fluxing agent may easily enter the ducts of the oxide microspheres and be distributed more uniformly, thereby facilitating the uniform growth of the fluorescent material inside the oxide microspheres during calcination and ensuring that the ducts collapse uniformly and densely. Therefore, the fluorescent performance and stability of the composite particle may be improved. In some examples, the first solvent may be water. Optionally, the first solvent may be ultrapure water. Therefore, the fluorescent material precursor may be dissolved easily. In some examples, an order of adding the fluorescent material precursor, the oxide material and the fluxing agent to the first solvent may not be limited. For example, the fluorescent material precursor may be added to the first solvent first, and then added with the oxide material and the fluxing agent; or the oxide material may be added with the fluxing agent first and then mixed with the fluorescent material precursor and the first solvent. In some examples, in the event of adding various components, the components may also be mixed uniformly by means of stirring or shaking, etc.

In some examples, the first mixture may be dried on a heating table. For example, the first mixture may be placed on the heating table at 75° C. and stirred continuously at a certain speed until the sample is dried to obtain the mixture powder.

In some examples, each oxide microsphere may have a particle size of 20 nm to 500 nm. For example, each oxide microsphere may have a particle size of 20 nm, 30 nm, 40 nm, 50 nm, 60 nm, 80 nm, 90 nm, 100 nm, 120 nm, 150 nm, 180 nm, 200 nm, 230 nm, 250 nm, 280 nm, 300 nm, 320 nm, 350 nm, 360 nm, 380 nm, 400 nm, 420 nm, 450 nm, 460 nm, 480 nm, or 500 nm. In this case, by selecting the oxide microspheres having a predetermined size, the composite particle having a predetermined size may be prepared easily.

In some examples, each mesopore of the oxide microspheres may have a pore size of 2 nm to 10 nm. For example, each mesopore of the oxide microspheres may have a pore size of 2 nm, 3 nm, 4 nm, 5 nm, 6 nm, 7 nm, 8 nm, 9 nm, or 10 nm. The pore sizes of the mesopores may affect the sizes of the nanocrystals. Specifically, in the process of high-temperature calcination, the ducts are softened, and the fluorescent material precursor is continuously melted and vaporized to crystallize in the ducts; and some nanocrystals will break through the limit of pore sizes and grow up till the sizes are larger than the pore sizes of the ducts, while some nanocrystals will be smaller than the pore sizes of the ducts. In this case, by selecting the oxide microspheres with an appropriate pore size of the mesopores, the nanocrystals that are within a predetermined range may be obtained easily. In addition, the morphologies of the mesopores in the oxide microspheres may refer to the schematic diagram shown in FIG. 3.

In some examples, a molar ratio of the fluorescent material precursor to the oxide material may be 10:1 to 1:100. For example, the molar ratio of the fluorescent material precursor to the oxide material may be 10:1, 5:1, 2:1, 1:1, 1:2, 1:5, 1:10, 1:20, 1:30, 1:40, 1:50, 1:60, 1:70, 1:80, 1:90, or 1:100. In this case, the oxide material may play a good role in protecting the fluorescent material. In addition, the photoelectric properties and fluorescent characteristics of the composite particle may be adjusted by adjusting the molar ratio of the fluorescent material to the oxide material. In some examples, optionally, the molar ratio of the fluorescent material precursor to the oxide material may be 1:1 to 1:100.

In some examples, the fluxing agent may be a salt compound. In some examples, the fluxing agent may be a potassium salt. For example, the fluxing agent may include one or more of potassium carbonate, potassium chloride, potassium bromide, potassium iodide, potassium fluoride, potassium hydroxide, and potassium sulfate. Therefore, the mesopores of the oxide microspheres may be caused to melt and collapse at high temperatures. In some examples, the fluxing agent may be a sodium salt. For example, the fluxing agent may include one or more of sodium carbonate, sodium chloride, sodium bromide, sodium iodide, sodium fluoride, sodium hydroxide, and sodium sulfate. Therefore, the mesopores of the oxide microspheres may be caused to melt and collapse at high temperatures. In some examples, the fluxing agent may be a rubidium salt. For example, the fluxing agent may include one or more of rubidium carbonate, rubidium chloride, rubidium bromide, rubidium iodide, rubidium fluoride, rubidium hydroxide, and rubidium sulfate. Therefore, the mesopores of the oxide microspheres may be caused to melt and collapse at high temperatures.

In some examples, a molar ratio of the fluxing agent to the fluorescent material precursor may be 0.1:1 to 2:1. For example, the molar ratio of the fluxing agent to the fluorescent material precursor may be 0.1:1, 0.2:1, 0.3:1, 0.4:1, 0.5:1, 0.8:1, 1:1, 1.2:1, 1.5:1, 1.8:1, or 2:1. Therefore, the mesopores of the oxide microspheres may be caused to melt and collapse at high temperatures. In the course of setting the molar ratio of the fluxing agent to the fluorescent material precursor, the molar amount of the fluxing agent is calculated as its host element. For example, in an example where the fluxing agent is the potassium salt, the molar amount of the fluxing agent is calculated in K.

In the preparation method II, the condition parameters for calcination are identical with the condition parameters for calcination in step S130 in the preparation method I, and the specific material selection, proportions, steps, conditions, etc. may refer to the description of step S130 in the above preparation method I, and will not be repeated here.

In summary, through the preparation method II in the third aspect of the present disclosure, the fluorescent composite particle with the predetermined morphology may be prepared, and the prepared composite particle has strong stability, small particle size, as well as good photoelectric properties and fluorescent characteristics.

Through the preparation method I and the preparation method II of the present disclosure, the fluorescent composite particle with the predetermined morphology may be prepared, and the prepared composite particle has strong stability, small particle size, as well as good photoelectric properties and fluorescent characteristics. That is, the composite particle involved in the first aspect of the present disclosure may be prepared through either the preparation method I and the preparation method II of the present disclosure.

The composite particles provided in the present disclosure and the preparation methods thereof are described in detail in conjunction with the examples and comparative examples, but they should not be construed as limiting the protection scope of the present disclosure.

### EMBODIMENTS

### Embodiment 1 (Using the Preparation Method I)

(1) Weigh 0.2 g of didodecyldimethylammonium bromide (surfactant) and dissolving in 100 mL of deionized water, add 0.8 mL of sodium hydroxide solution (catalyst) with a concentration of 2 mol/L, and stir at 75° C. for 30 min;
(2) Weigh 0.8 mmol of precursor CsBr and 0.8 mmol of precursor PbBr₂ (fluorescent material precursor), add to the above solution, and stir at 75° C. for 30 min;
(3) Pipet 2 mL of tetramethyl silicate (oxide precursor) and add to the above solution, and stir at 75° C. for 200 min to form a mixed solution;
(4) Adding 300 mL of acetone (organic solvent) to the above mixed solution, shaking fully, and centrifuging at 10000 rpm for 5 min, and taking a bottom precipitate taken and drying at 80° C. to obtain a solid powder;
(5) Spread the solid powder uniformly into a corundum crucible, and then place the corundum crucible in a high-temperature furnace in an air atmosphere;
(6) Set a temperature rise rate of the high-temperature furnace to 5° C./min, and raise the temperature to 600° C. and maintain for 60 min, and then naturally cooling to room temperature; take out the corundum crucible; and
(7) Grind the above-mentioned calcined sample fully, and then disperse in 100 mL of water; washing away instable perovskite nanocrystals and their precursors on the surface of the sample, and perform centrifugation at a speed of 10000 rpm for 5 min and repeat for three times; and dry the centrifuged precipitate in a constant-temperature drying oven at 80° C. for 3 h to obtain the CsPbBr₃—SiO₂ composite particle in Embodiment 1.

The CsPbBr₃—SiO₂ composite particle prepared in Embodiment 1 is tested for TEM, mapping, XRD, fluorescence spectroscopy, and photoluminescence light attenuation.

FIG. 5 is TEM (transmission electron microscope) and mapping (element distribution) diagrams illustrating a CsPbBr₃—SiO₂ composite particle in Embodiment 1 of the present disclosure. In FIG. 5, a in FIG. 5 is a BF (brightfield) diagram of the CsPbBr₃—SiO₂ composite particle. It may be seen from the BF diagram that CsPbBr₃ nanocrystals and SiO₂ formed fluorescent microspheres/nanospheres with a diameter of 200 nm, and the CsPbBr₃ nanocrystals are densely coated with SiO₂. The CsPbBr₃ nanocrystals have uniform size distribution and an average particle size of about 7.6 nm. b to f in FIG. 5 are mapping diagrams of the CsPbBr₃ nanocrystals. It may be seen that Cs, Pb, and Br elements are mainly concentrated inside SiO₂ microspheres/nanospheres and coated with Si and O elements.

FIG. 6 is an optical photograph illustrating the CsPbBr₃—SiO₂ composite particle in Embodiment 1 of the present disclosure. In FIG. 6, the CsPbBr₃—SiO₂ composite particle presents a yellow green powder (the yellow green color was indistinguishable due to a grayscale photograph, optical photographs in the subsequent other examples are also indistinguishable because they are grayscale photographs, and the actual color of the composite particle in each embodiment may be shown in Table 1 below).

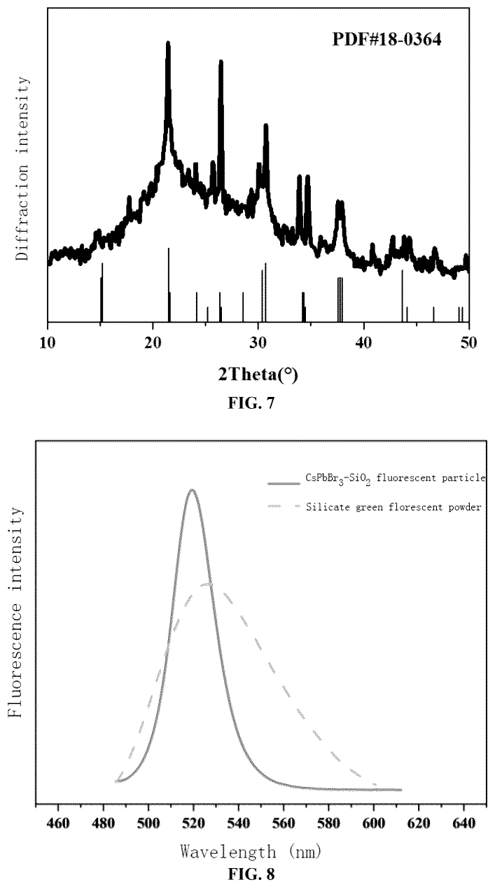

FIG. 7 is an XRD (X-ray diffraction) diagram illustrating the CsPbBr₃—SiO₂ composite particle in Embodiment 1 of the present disclosure. In FIG. 7, it may be seen from the XRD diagram that the obtained CsPbBr₃—SiO₂ composite particle presents a monoclinic perovskite structure (#18-0346 corresponding to a PDF card), which fully proves that CsPbBr₃ nanocrystals are formed in a high-temperature calcination environment.

FIG. 8 is a comparative diagram of fluorescence spectra of the CsPbBr₃—SiO₂ composite particle in Embodiment 1 of the present disclosure and a commercially available silicate green florescent powder. The commercially available silicate green fluorescent powder is a Sr₂SiO₄:Eu²⁺ green fluorescent powder sold by Interme (Intermtix.co) in Silicon Valley, California, USA. This green fluorescent powder gains great commercial applications due to its good stability, low cost and high fluorescence efficiency. It may be seen from FIG. 8 that the CsPbBr₃—SiO₂ composite particle obtained in Embodiment 1 has a narrow half-peak width, which is much lower than that of the commercially available silicate green fluorescent powder, and therefore, has great application potential.

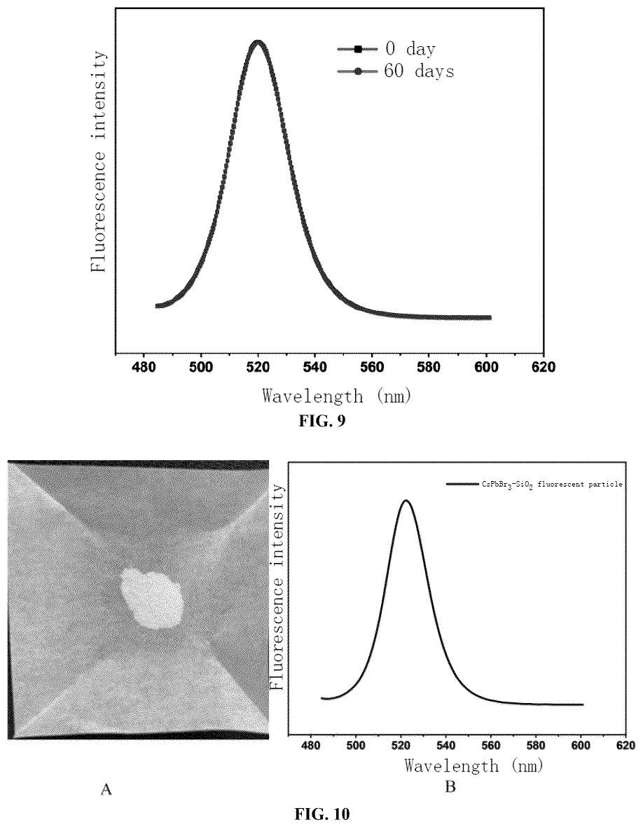

FIG. 9 is a variation diagram of fluorescence spectra of the CsPbBr₃—SiO₂ composite particle in Embodiment 1 of the present disclosure soaked in a hydrochloric acid solution for 0 day and 60 days. As shown in FIG. 9, a CsPbBr₃—SiO₂ composite particle powder is impregnated in a chemical reagent (1 mol/L hydrochloric acid solution) for 60 days, and there is no fluorescence attenuation, showing excellent chemical reagent stability and further proving the compact level of CsPbBr₃ nanocrystals coated with silicon dioxide.

### Embodiment 2 (Using the Preparation Method I)

(1) Weigh 1.5 g of F127 ((CH₂CH₂O)₁₀₆(CH₃CHCH₂O)₇₀(CH₂CH₂O)₁₀₆) and dissolve in 40 mL of tetrahydrofuran as a surfactant, add 0.5 mL of ammonia water (catalyst) and stir at 25° C. for 30 min;
(2) Weigh 0.6 mmol of precursor CsBr and 0.6 mmol of precursor PbBr₂ (fluorescent material precursor), add to the above solution, and stir at 25° C. for 30 min;
(3) Pipet 2 mL of tetramethoxysilane (oxide precursor) and add to the above solution, and stir at 25° C. for 10 min to form a mixed solution;
(4) Pipet the above mixed solution to a volumetric flask, put the volumetric flask in a blast drying oven, evaporate at 40° C. for 20 h, and then evaporate at 80° C. for another 8 h to form a white powder;
(5) Spread the white powder uniformly into a corundum crucible, and then place the corundum crucible in a high-temperature furnace in an air atmosphere;
(6) Set a temperature rise rate of the high-temperature furnace to 5° C./min, and raise the temperature to 500° C. and maintain for 300 min, then naturally cool to room temperature; take out the corundum crucible; and
(7) Grind the above-mentioned calcined sample fully, and then disperse in 100 mL of water; wash away instable perovskite nanocrystals and their precursors on the surface of the sample, and perform centrifugation at a speed of 10000 rpm for 5 min and repeat for three times; and dry the centrifuged precipitate in a constant-temperature drying oven at 80° C. for 3 h to obtain a CsPbBr₃—SiO₂ composite particle in Embodiment 2.

FIG. 10 is a schematic diagram illustrating a CsPbBr₃—SiO₂ composite particle in Embodiment 2 of the present disclosure. FIG. A on the left side of FIG. 10 is an optical photograph, and FIG. B on the right side is a fluorescence spectrum diagram.

### Embodiment 3 (Using the Preparation Method II)

(1) Weigh 0.6 mmol of precursor CsBr and 0.6 mmol of precursor PbBr₂ (fluorescent material precursor) and dissolve in 50 mL of ultrapure water, and stir continuously to form a clear solution;
(2) Weigh 1043.7 mg of pre-synthesized silicon oxide microspheres (having a mesopore size of 3.0 nm) and add to the above solution, and stir for 30 min to form a mixed solution;
(3) Add 0.3 mmol of K₂CO₃ (fluxing agent) to the above mixed solution, and stir for 30 min;
(4) Place the above mixed solution on a heating table at 75° C., and continuously stir at a speed of 400 rpm until dry to obtain a solid powder;
(5) Spread the above solid powder uniformly into a corundum crucible, and then place the corundum crucible in a high-temperature furnace;
(6) Set a temperature rise rate of the high-temperature furnace to 5° C./min, and raise the temperature raised to 600° C. and maintaining for 30 min, then naturally cool to room temperature; take out the corundum crucible; and
(7) Grind the above-mentioned calcined sample fully, and then disperse in 50 mL of water; wash away instable perovskite nanocrystals and their precursors on the surface of the sample, and perform centrifugation at a speed of 10000 rpm for 5 min and repeat for three times; and dry the centrifuged precipitate in a vacuum drying oven at 50° C. for 6 h to obtain a CsPbBr₃—SiO₂ composite particle in Embodiment 3.

FIG. 11 is a TEM diagram illustrating a CsPbBr₃—SiO₂ composite particle in Embodiment 3 of the present disclosure.

### Embodiment 4 (Using the Preparation Method I)

(1) Weigh 0.2 g of didodecyldimethylammonium bromide (surfactant) and dissolve in 100 mL of deionized water, add 0.8 mL of sodium hydroxide solution (catalyst) with a concentration of 2 mol/L, and stir at 75° C. for 30 min;
(2) Weigh 1.2 mmol of precursor CdCl₂ and 1.2 mmol of precursor se (fluorescent material precursor), add to the above solution, and stir at 75° C. for 30 min;
(3) Pipet 2 mL of tetramethyl silicate (oxide precursor) and add to the above solution, and stir at 75° C. for 200 min to form a mixed solution;
(4) Add 300 mL of acetone (organic solvent) to the above mixed solution, shake fully, and centrifuge at a speed of 10000 rpm for 5 min, and take a bottom precipitate and dry at 80° C.;
(5) Spread the above-mentioned dried solid powder uniformly into a corundum crucible, and then place the corundum crucible in a high-temperature furnace in an air atmosphere; set a temperature rise rate of the high-temperature furnace to 5° C./min, raise the temperature to 350° C. and maintain for 200 min; then introducing argon to make the temperature rise to 600° C. at 10° C./min in the argon atmosphere, and maintain the temperature for 30 min, then natural cool to room temperature; take out the corundum crucible;
(6) Grind the above-mentioned calcined sample fully, and then disperse in 100 mL of water; wash away instable perovskite nanocrystals and their precursors on the surface of the sample, and perform centrifugation at 10000 rpm for 5 min and repeat for three times; and dry the centrifuged precipitate in a constant-temperature drying oven at 80° C. for 3 h to obtain a CdSe—SiO₂ composite particle in Embodiment 4.

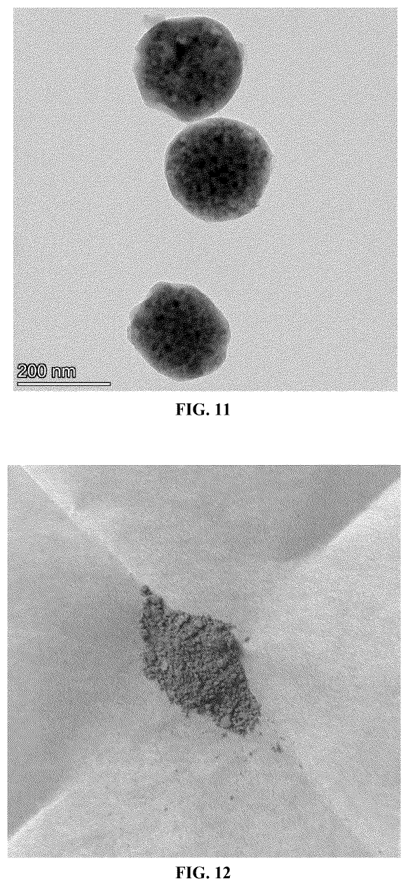

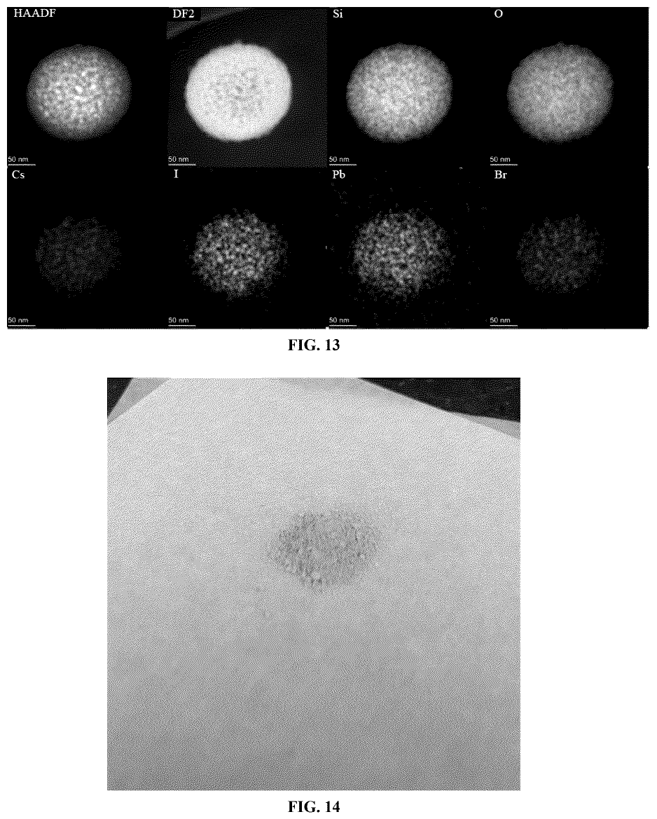

FIG. 12 is an optical photograph illustrating a CdSe—SiO₂ composite particle powder in Embodiment 4 of the present disclosure.

### Embodiment 5 (Using the Preparation Method II)

(1) Weigh 0.3 mmol of precursor CsBr, 0.3 mmol of precursor PbBr₂, 0.3 mmol of precursor PbI₂ and 0.3 mmol of precursor CsI (fluorescent material precursor) and dissolve in 50 mL of ultrapure water, and stir continuously to form a clear solution;
(2) Weigh 1170.6 mg of pre-synthesized mesoporous silicon oxide microspheres (having a mesopore size of 3.0 nm) and add to the above solution, and stir for 30 min to form a mixed solution;
(3) Add 0.3 mmol of K₂CO₃ (fluxing agent) to the above mixed solution, and stir for 30 min;
(4) Place the above mixed solution on a heating table at 50° C., and continuously stir at a speed of 400 rpm until dry to obtain a solid powder;
(5) Spread the above solid powder uniformly into a corundum crucible, and then place the corundum crucible in a high-temperature furnace filled with argon;
(6) Set a temperature rise rate of the high-temperature furnace to 10° C./min, and raise the temperature to 600° C. and maintain for 30 min, then naturally cool to room temperature; take out the corundum crucible; and
(7) Grind the above-mentioned calcined sample fully, and then disperse in 50 mL of water; wash away instable perovskite nanocrystals and their precursors on the surface of the sample, and perform centrifugation at a speed of 10000 rpm for 5 min and repeat for three times; and dry the centrifuged precipitate in a vacuum drying oven at 50° C. for 6 h to obtain a CsPbBr_{1.5}I_{1.5}—SiO₂ composite particle in Embodiment 5.

FIG. 13 is TEM and mapping diagrams illustrating a CsPbBr_{1.5}I_{1.5}—SiO₂ composite particle in Embodiment 5 of the present disclosure.

FIG. 14 is an optical photograph illustrating the CsPbBr_{1.5}I_{1.5}—SiO₂ composite particle in Embodiment 5 of the present disclosure.

### Embodiment 6 (Using the Preparation Method II)

(1) Weigh 0.6 mmol of precursor PbI₂ and 0.6 mmol of precursor CsI (fluorescent material precursor) and dissolve in 50 mL of ultrapure water, and stir continuously to form a clear solution;
(2) Weigh 865 mg of pre-synthesized mesoporous silicon oxide microspheres (having a mesopore size of 3.0 nm) and add to the above solution, and stir for 30 min to form a mixed solution;
(3) Add 0.3 mmol of K₂CO₃ (fluxing agent) to the above mixed solution, and stir for 30 min;
(4) Place the above mixed solution on a heating table at 50° C., and continuously stir at a speed of 400 rpm until dry to obtain a solid powder;
(5) Spread the above solid powder uniformly into a corundum crucible, and then place the corundum crucible in a high-temperature furnace filled with argon;
(6) Set a temperature rise rate of the high-temperature furnace to 10° C./min, and raise the temperature to 600° C. and maintain for 30 min, then naturally cool to room temperature; take out the corundum crucible; and
(7) Grind the above-mentioned calcined sample fully, and then disperse in 50 mL of water; wash away instable perovskite nanocrystals and their precursors on the surface of the sample, and perform centrifugation at a speed of 10000 rpm for 5 min and repeat for three times; and dry the centrifuged precipitate in a vacuum drying oven at 50° C. for 6 h to obtain a CsPbI₃—SiO₂ composite particle in Embodiment 6.

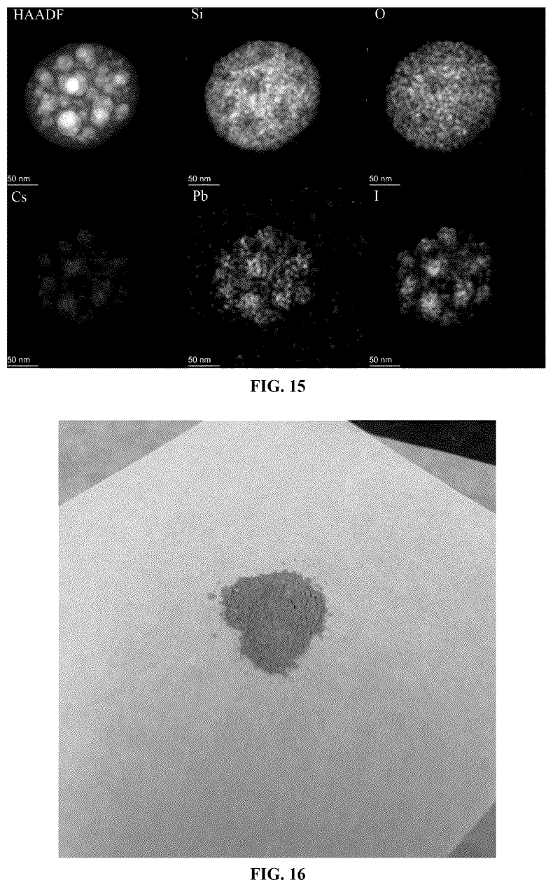

FIG. 15 is TEM and mapping diagrams illustrating a CsPbI₃—SiO₂ composite particle in Embodiment 6 of the present disclosure.

FIG. 16 is an optical photograph illustrating a CsPbI₃—SiO₂ composite particle powder in Embodiment 6 of the present disclosure.

### Embodiment 7 (Using the Preparation Method I)

(1) Weigh 0.2 g of didodecyldimethylammonium bromide (surfactant) and dissolve in 100 mL of deionized water, adding 0.4 mL of sodium hydroxide solution (catalyst) with a concentration of 2 mol/L, and stir at 75° C. for 30 min;
(2) Weigh 0.8 mmol of precursor CsBr and 0.8 mmol of precursor PbBr₂ (fluorescent material precursor), add to the above solution, and stir at 75° C. for 30 min;
(3) Pipet 1 mL of tetramethyl silicate (oxide precursor) and add to the above solution, and stir at 75° C. for 200 min to form a mixed solution;
(4) Add 300 mL of acetone (organic solvent) to the above mixed solution, shake fully, and centrifuge at a speed of 10000 rpm for 5 min, and take a bottom precipitate and dry at 80° C.;
(5) Spread the dried solid powder uniformly into a corundum crucible, and then place the corundum crucible in a high-temperature furnace in an air atmosphere;
(6) Set a temperature rise rate of the high-temperature furnace to 5° C./min, and raise the temperature to 600° C. and maintain for 60 min, then naturally cool to room temperature; take out the corundum crucible; and
(7) Grind the above-mentioned calcined sample fully, and then disperse in 100 mL of water; wash away instable perovskite nanocrystals and their precursors on the surface of the sample, and perform centrifugation at a speed of 10000 rpm for 5 min and repeat for three times; and dry the centrifuged precipitate in a constant-temperature drying oven at 80° C. for 3 h to obtain a CsPbBr₃—SiO₂ composite particle in Embodiment 7.

FIG. 17 is a TEM diagram illustrating a CsPbBr₃—SiO₂ composite particle in Embodiment 7 of the present disclosure.

### Embodiment 8 (Using the Preparation Method I)

(1) Weigh 0.2 g of didodecyldimethylammonium bromide (surfactant) and dissolve in 100 mL of deionized water, add 0.8 mL of sodium hydroxide solution (catalyst) with a concentration of 2 mol/L, and stir at 75° C. for 30 min;
(2) Weigh 0.8 mmol of precursor CsBr, 0.8 mmol of precursor PbBr₂ (fluorescent material precursor) and 0.2 mmol of fluxing agent K₂CO₃, add to the above solution, and stir at 75° C. for 30 min;
(3) Pipet 2 mL of tetramethyl silicate (oxide precursor) and add to the above solution, and stir at 75° C. for 200 min to form a mixed solution;
(4) Add 300 mL of acetone (organic solvent) to the above mixed solution, shake fully, and centrifuge at 10000 rpm for 5 min, and take a bottom precipitate and drying at 80° C. to obtain a solid powder;
(5) Spread the solid powder uniformly into a corundum crucible, and then place the corundum crucible in a high-temperature furnace in an air atmosphere;
(6) Set a temperature rise rate of the high-temperature furnace to 5° C./min, and raise the temperature to 500° C. and maintain for 180 min, then naturally cool to room temperature; take out the corundum crucible; and
(7) Grind the above-mentioned calcined sample fully, and then disperse in 100 mL of water; wash away instable perovskite nanocrystals and their precursors on the surface of the sample, and perform centrifugation at a speed of 10000 rpm for 5 min and repeat for three times; and dry the centrifuged precipitate in a constant-temperature drying oven at 80° C. for 3 h to obtain a CsPbBr₃—SiO₂ composite particle in Embodiment 8.

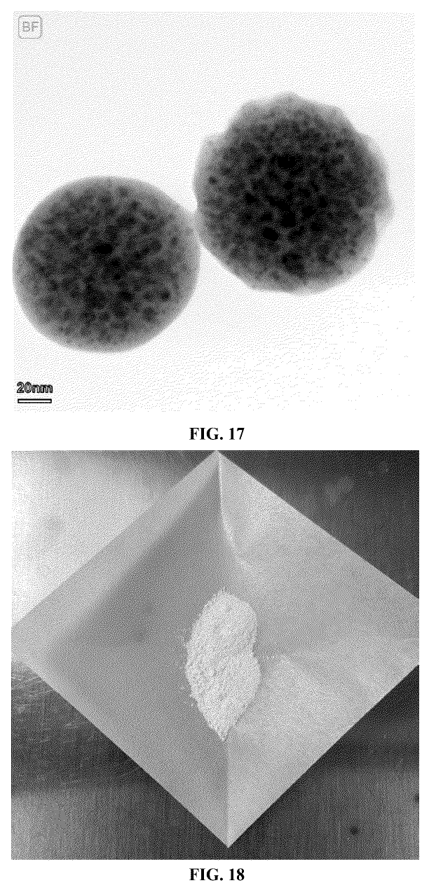

FIG. 18 is an optical photograph illustrating a CsPbBr₃—SiO₂ composite particle in Embodiment 8 of the present disclosure.

### Embodiment 9 (Using the Preparation Method I)

(1) Weigh 1.5 g of F127 ((CH₂CH₂O)₁₀₆(CH₃CHCH₂O)₇₀(CH₂CH₂O)₁₀₆) and dissolve in 40 mL of tetrahydrofuran as a surfactant, adding 0.5 mL of ammonia water (catalyst) and stir at 25° C. for 30 min;
(2) Weigh 0.6 mmol of precursor CsBr, 0.6 mmol of precursor PbBr₂ (fluorescent material precursor) and 0.15 mmol of fluxing agent K₂CO₃, add to the above solution, and stir at 25° C. for 30 min;
(3) Pipet 2 mL of tetramethoxysilane (oxide precursor) and add to the above solution, and stir at 25° C. for 10 min to form a mixed solution;
(4) Pipet the above mixed solution to a volumetric flask, put the volumetric flask in a blast drying oven, evaporate at 40° C. for 20 h, and then evaporate at 80° C. for another 8 h to form a white powder;
(5) Spread the white powder uniformly into a corundum crucible, and then place the corundum crucible in a high-temperature furnace in an air atmosphere;
(6) Set a temperature rise rate of the high-temperature furnace to 5° C./min, and raise the temperature to 500° C. and maintain for 100 min, then naturally cool to room temperature; take out the corundum crucible; and
(7) Grind the above-mentioned calcined sample fully, and then disperse in 100 mL of water; wash away instable perovskite nanocrystals and their precursors on the surface of the sample, and perform centrifugation at a speed of 10000 rpm for 5 min and repeat for three times; and dry the centrifuged precipitate in a constant-temperature drying oven at 80° C. for 3 h to obtain a CsPbBr₃—SiO₂ composite particle in Embodiment 9.

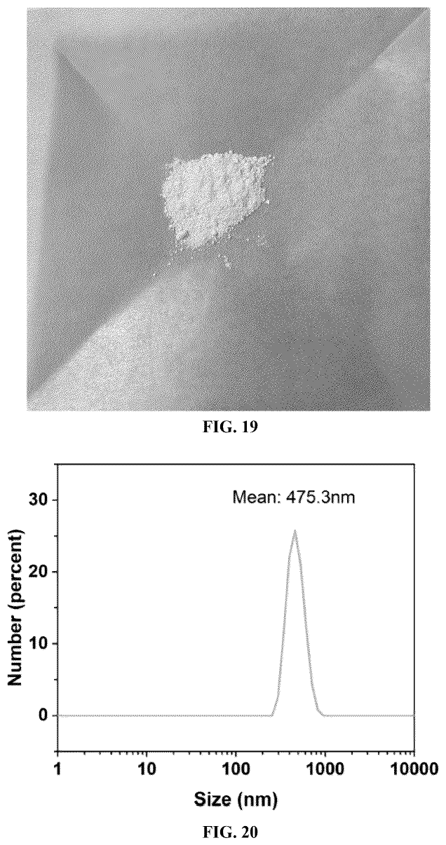

FIG. 19 is an optical photograph illustrating a CsPbBr₃—SiO₂ composite particle in Embodiment 9 of the present disclosure.

### Embodiment 10 (Using the Preparation Method II)

(1) Weigh 0.6 mmol of precursor CsBr and 0.6 mmol of precursor PbBr₂ (fluorescent material precursor) and dissolve in 50 mL of ultrapure water, and stir continuously to form a clear solution;
(2) Weigh 1043.7 mg of pre-synthesized silicon oxide microspheres (having a mesopore size of 3.0 nm) and add to the above solution, and stirring for 30 min to form a mixed solution;
(3) Add 0.3 mmol of K₂CO₃ (fluxing agent) to the above mixed solution, and stir for 30 min;
(4) Place the above mixed solution on a heating table at 75° C., and continuously stir at a speed of 400 rpm until dry to obtain a solid powder;
(5) Spread the above solid powder uniformly into a corundum crucible, and then place the corundum crucible in a high-temperature furnace;
(6) Set a temperature rise rate of the high-temperature furnace to 5° C./min, and raise the temperature to 600° C. and maintain for 30 min, then naturally cool to room temperature; take out the corundum crucible; and
(7) Grind the above-mentioned calcined sample fully, and then disperse in 50 mL of water; wash away instable perovskite nanocrystals and their precursors on the surface of the sample, and perform centrifugation at a speed of 10000 rpm for 5 min and repeat for three times; and dry the centrifuged precipitate in a vacuum drying oven at 50° C. for 6 h to obtain a CsPbBr₃—SiO₂ composite particle in Embodiment 10.

FIG. 20 is a size distribution diagram illustrating a CsPbBr₃—SiO₂ composite particle in Embodiment 10 of the present disclosure which is measured by dynamic light scattering.

### Embodiment 11 (Using the Preparation Method I)

(1) Weigh 0.2 g of didodecyldimethylammonium bromide (surfactant) and dissolve in 100 mL of deionized water, add 0.25 mL of sodium hydroxide solution (catalyst) with a concentration of 2 mol/L, and stir at 75° C. for 30 min;
(2) Weigh 0.8 mmol of precursor CsBr and 0.8 mmol of precursor PbBr₂ (fluorescent material precursor), add to the above solution, and stir at 75° C. for 30 min;
(3) Pipet 0.8 mL of tetramethyl silicate (oxide precursor) and add to the above solution, and stir at 75° C. for 200 min to form a mixed solution;
(4) Add 300 mL of acetone (organic solvent) to the above mixed solution, shake fully, and centrifuge at a speed of 10000 rpm for 5 min, and take a bottom precipitate and drying at 80° C.;
(5) Spread the dried solid powder uniformly into a corundum crucible, and then place the corundum crucible in a high-temperature furnace in an air atmosphere;
(6) Set a temperature rise rate of the high-temperature furnace to 5° C./min, and raise the temperature to 600° C. and maintain for 60 min, then naturally cool to room temperature; take out the corundum crucible; and
(7) Grind the above-mentioned calcined sample fully, and then disperse in 100 mL of water; wash away instable perovskite nanocrystals and their precursors on the surface of the sample, and perform centrifugation at a speed of 10000 rpm for 5 min and repeat for three times; and dry the centrifuged precipitate in a constant-temperature drying oven at 80° C. for 3 h to obtain a CsPbBr₃—SiO₂ composite particle in Embodiment 11.

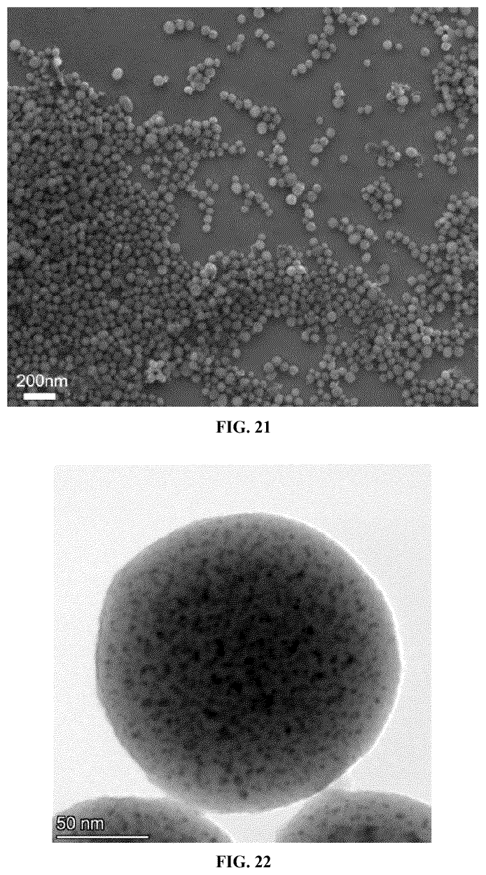

FIG. 21 is a SEM (scanning electron microscope) diagram illustrating a CsPbBr₃—SiO₂ composite particle in Embodiment 11 of the present disclosure.

### Embodiment 12 (Using the Preparation Method II)

(1) Weigh 0.3 mmol of precursor CsBr and 0.3 mmol of precursor PbBr₂ (fluorescent material precursor) and dissolve in 50 mL of ultrapure water, and stir continuously to form a clear solution;
(2) Weigh 1043.7 mg of pre-synthesized silicon oxide microspheres (having a mesopore size of 3.0 nm) and add to the above solution, and stir for 30 min to form a mixed solution;
(3) Add 0.3 mmol of K₂CO₃ (fluxing agent) to the above mixed solution, and stir for 30 min;
(4) Place the above mixed solution on a heating table at 75° C., and continuously stir at a speed of 400 rpm until dry to obtain a solid powder;
(5) Spread the above solid powder uniformly into a corundum crucible, and then place the corundum crucible in a high-temperature furnace;
(6) Set a temperature rise rate of the high-temperature furnace to 5° C./min, and raise the temperature to 600° C. and maintain for 10 min, then naturally cool to room temperature; take out the corundum crucible; and
(7) Grind the above-mentioned calcined sample fully, and then disperse in 50 mL of water; wash away instable perovskite nanocrystals and their precursors on the surface of the sample, and perform centrifugation at a speed of 10000 rpm for 5 min and repeat for three times; and dry the centrifuged precipitate in a vacuum drying oven at 50° C. for 6 h to obtain a CsPbBr₃—SiO₂ composite particle in Embodiment 12.

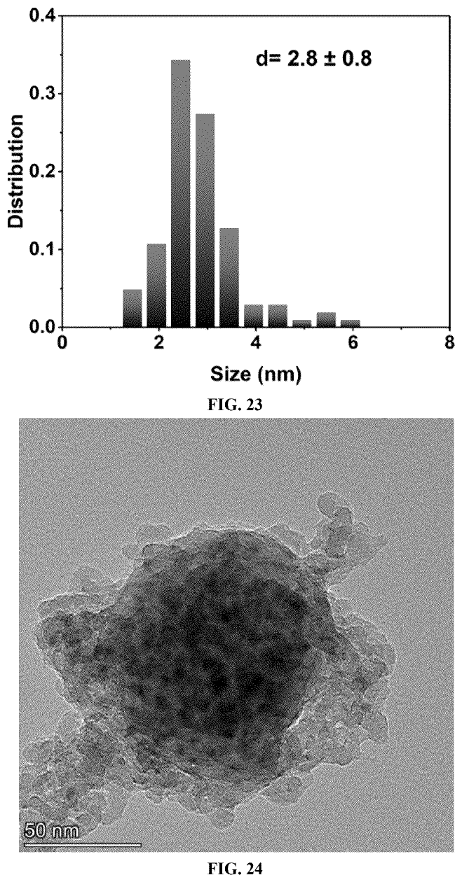

FIG. 22 is a TEM diagram illustrating a CsPbBr₃—SiO₂ composite particle in Embodiment 12 of the present disclosure. FIG. 23 is a size distribution diagram of nanocrystals obtained based on the TEM diagram of FIG. 22.

### Embodiment 13 (Using the Preparation Method I)

(1) Weigh 0.2 g of didodecyldimethylammonium bromide (surfactant) and dissolve in 100 mL of deionized water, add 0.4 mL of sodium hydroxide solution (catalyst) with a concentration of 2 mol/L, and stir at 75° C. for 30 min;
(2) Weigh 1.2 mmol of precursor CsBr and 1.2 mmol of precursor PbBr₂ (fluorescent material precursor), add to the above solution, and stir at 75° C. for 30 min;
(3) Pipet 1 mL of tetramethyl silicate (oxide precursor) and add to the above solution, and stir at 75° C. for 200 min to form a mixed solution;
(4) Centrifuge the above mixed solution at a speed of 10000 rpm for 5 min, and take a bottom precipitate and dry at 80° C. to obtain a solid powder;
(5) Spread the solid powder uniformly into a corundum crucible, and then place the corundum crucible in a high-temperature furnace in an air atmosphere;
(6) Set a temperature rise rate of the high-temperature furnace to 5° C./min, and raise the temperature to 600° C. and maintain for 60 min, then naturally cool to room temperature; take out the corundum crucible; and
(7) Grind the above-mentioned calcined sample fully, and then disperse in 100 mL of water; wash away instable perovskite nanocrystals and their precursors on the surface of the sample, and perform centrifugation at a speed of 10000 rpm for 5 min and repeat for three times; and dry the centrifuged precipitate in a constant-temperature drying oven at 80° C. for 3 h to obtain a CsPbBr₃—SiO₂ composite particle in Embodiment 13.

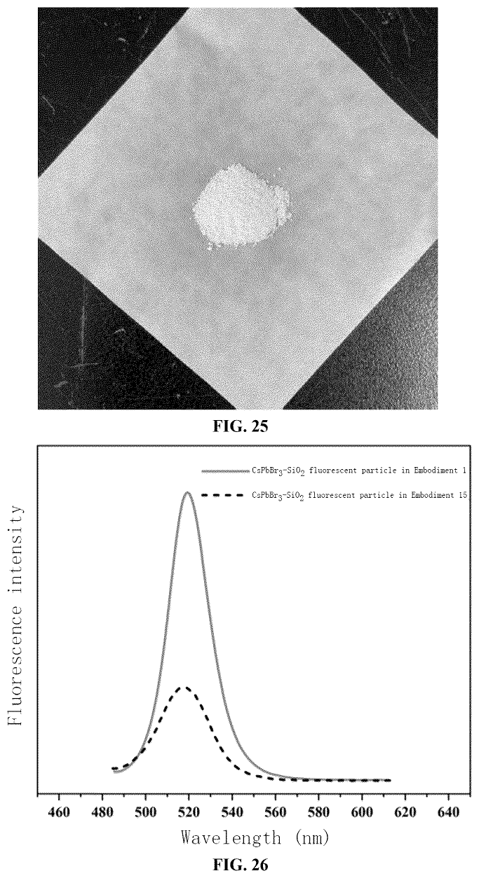

FIG. 24 is a TEM diagram illustrating a CsPbBr₃—SiO₂ composite particle in Embodiment 13 of the present disclosure.

### Embodiment 14 (Using the Preparation Method II)

(1) Weigh 1043.7 mg of pre-synthesized silicon oxide microspheres (having a mesopore size of 3.0 nm) and add into 100 mL of deionized water, adding 0.6 mmol of K₂CO₃ (fluxing agent), and stir for 24 h;
(2) Centrifuge the above mixed solution at a speed of 10000 rpm for 5 min; dry a bottom precipitate at 80° C. and uniformly spread into a corundum crucible; then place the corundum crucible in a high-temperature furnace at 5° C./min; raise the temperature to 500° C. and maintain for 200 min, then naturally cool to obtain silicon oxide microspheres modified with K₂CO₃ (fluxing agent).
(3) Weigh 0.6 mmol of precursor CsBr and 0.6 mmol of precursor PbBr₂ (fluorescent material precursor) and dissolve in 50 mL of ultrapure water, and stir continuously to form a clear solution;
(4) Weigh 1043.7 mg of silicon oxide microspheres modified with K₂CO₃ (fluxing agent) and add to the above solution, and stirring for 30 min to form a mixed solution;
(5) Place the above mixed solution on a heating table at 75° C., and continuously stir at a speed of 400 rpm until dry to obtain a solid powder;
(6) Spread the above solid powder uniformly into a corundum crucible, and then place the corundum crucible in a high-temperature furnace;
(7) Set a temperature rise rate of the high-temperature furnace to 5° C./min, and raise the temperature to 600° C. and maintained for 30 min, then naturally cool to room temperature; take out the corundum crucible; and
(8) Grind the above-mentioned calcined sample fully, and then disperse in 50 mL of water; wash away instable perovskite nanocrystals and their precursors on the surface of the sample, and perform centrifugation at a speed of 10000 rpm for 5 min and repeat for three times; and dry the centrifuged precipitate in a vacuum drying oven at 50° C. for 6 h to obtain the CsPbBr₃—SiO₂ composite particle in Embodiment 14.

FIG. 25 is an optical photograph illustrating a CsPbBr₃—SiO₂ composite particle in Embodiment 14 of the present disclosure.

### Embodiment 15 (Using the Preparation Method II)

(1) Weigh 1043.7 mg of pre-synthesized silicon oxide microspheres (having a mesopore size of 3.0 nm) and add into 100 mL of deionized water, add 0.6 mmol of K₂CO₃ (fluxing agent), and stir for 24 h;
(2) Centrifuge the above mixed solution at a speed of 10000 rpm for 5 min; dry a bottom precipitate at 80° C. and uniformly spread into a corundum crucible; then place the corundum crucible in a high-temperature furnace at 5° C./min; raise the temperature to 500° C. and maintain for 200 min to obtain silicon oxide microspheres modified with K₂CO₃ (fluxing agent);
(3) Weigh 0.6 mmol of precursor CsBr, 0.6 mmol of precursor PbBr₂ (fluorescent material precursor) and 1043.7 mg of silicon oxide microspheres modified with K₂CO₃ (fluxing agent) and place into a mortar, and grind to obtain a solid powder;
(4) Spread the above solid powder uniformly into a corundum crucible, and then place the corundum crucible in a high-temperature furnace;
(5) Set a temperature rise rate of the high-temperature furnace set to 5° C./min, and raise the temperature to 600° C. and maintain for 30 min, then naturally cool to room temperature; take out the corundum crucible; and
(6) Grind the above-mentioned calcined sample fully, and then disperse in 50 mL of water; wash away instable perovskite nanocrystals and their precursors on the surface of the sample, and perform centrifugation at a speed of 10000 rpm for 5 min and repeat for three times; and dry the centrifuged precipitate in a vacuum drying oven at 50° C. for 6 h to obtain a CsPbBr₃—SiO₂ composite particle in Embodiment 15.

FIG. 26 is a comparative diagram of fluorescence spectra of a CsPbBr₃—SiO₂ composite particle in Embodiment 15 of the present disclosure and the CsPbBr₃—SiO₂ composite particle in Embodiment 1.

### Embodiment 16 (Using the Preparation Method II)

(1) Weigh 1.2 mmol of precursor CsBr and 0.6 mmol of precursor PbBr₂ (fluorescent material precursor) and dissolve in 50 mL of ultrapure water, and stir continuously to form a clear solution;
(2) Weigh 1043.7 mg of pre-synthesized silicon oxide microspheres (having a mesopore size of 3.0 nm) and add to the above solution, and stir for 30 min to form a mixed solution;
(3) Add 0.3 mmol of K₂CO₃ (fluxing agent) to the above mixed solution, and stir for 30 min;
(4) Placing the above mixed solution on a heating table at 75° C., and continuously stirring at a speed of 400 rpm until dry to obtain a solid powder;
(5) Spread the above solid powder uniformly into a corundum crucible, and then place the corundum crucible in a high-temperature furnace;
(6) Set a temperature rise rate of the high-temperature furnace to 5° C./min, and raise the temperature to 600° C. and maintain for 30 min, then naturally cool to room temperature; take out the corundum crucible; and
(7) Grind the above-mentioned calcined sample fully, and then disperse in 50 mL of water; wash away instable perovskite nanocrystals and their precursors on the surface of the sample, and perform centrifugation at a speed of 10000 rpm for 5 min and repeat for three times; and dry the centrifuged precipitate in a vacuum drying oven at 50° C. for 6 h to obtain a CsPbBr₃@Cs₄PbBr₆—SiO₂ composite particle in Embodiment 16.

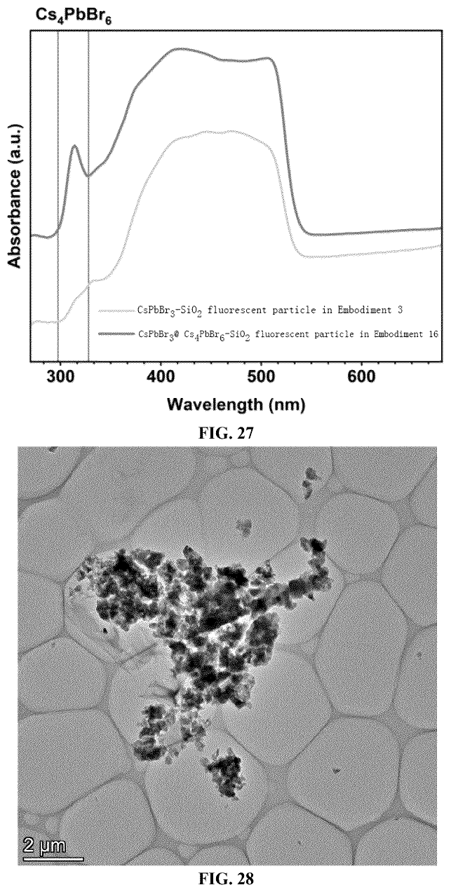

FIG. 27 is a comparative diagram of ultraviolet-visible absorption spectra of a CsPbBr₃@Cs₄PbBr₆—SiO₂ composite particle in Embodiment 16 of the present disclosure and the CsPbBr₃—SiO₂ composite particle in Embodiment 3.

### COMPARATIVE EXAMPLES

### Comparative Example 1 (Liquid Phase Coating Method)

Hydrolyzing Silicon dioxide at room temperature to coat CsPbBr₃ quantum dots: introduce 100 μL of tetramethyl silicate into a 50 mL three-neck flask containing 20 mL of colloidal CsPbBr₃ quantum dot toluene solution (0.64 mg/mL, water content of 0.0623%), and plug a sealing plug to the flask mouth; place the sealed three-neck flask in a humidity-temperature chamber at a temperature of 25° C. and relative humidity of 60%. After stirring for 36 h, collect a precipitate by centrifugation at 10000 rpm for 10 min, and freeze-dry to obtain a CsPbBr₃—SiO₂ composite particle in Comparative example 1.

### Comparative Example 2 (High-Temperature Solid-Phase Method)

(1) Weigh 0.6 mmol of precursor CsBr and 0.6 mmol of precursor PbBr₂ and dissolve in 50 mL of ultrapure water, and stir continuously to form a clear solution;
(2) Weigh an MCM mesoporous molecular sieve (having a mass of 1047.3 mg and a pore size of 3.6 nm) which is 3 times the total mass of the precursors (CsBr and PbBr₂) and add to the above solution, and stir at 60° C. for 30 min to form a mixed solution;
(3) Place the above-mentioned mixed solution in a constant-temperature drying oven, set the temperature of the constant-temperature drying oven set to 100° C., and dry the mixed solution for 12 h to obtain a solid powder;
(4) Spread the above solid powder uniformly into a corundum crucible, and then place the corundum crucible in a high-temperature furnace;
(5) Set a temperature rise rate of the high-temperature furnace to 5° C./min, and raise the temperature to 700° C. and maintain for 30 min, then naturally cool to room temperature; take out the corundum crucible; and
(6) Grind a reactant after the above reaction fully, and then disperse in 50 mL of water; wash away instable perovskite nanocrystals on the surface of a molecular sieve, and perform centrifugation at a speed of 10000 rpm for 1 min and repeat for three times; and dry the centrifuged precipitate in a constant-temperature drying oven at 60° C. for 6 h to obtain a CsPbBr₃—SiO₂ composite particle in Comparative example 2.

FIG. 28 is a TEM diagram illustrating a CsPbBr₃—SiO₂ composite particle in Comparative example 2 of the present disclosure.

### Comparative Example 3 (Liquid-Phase Thermal Injection Method)

Weigh 20 mL of octadecene, 5 mL of oleamine, 5 mL of oleic acid and 2 mmol of PbBr₂ and transfer to a 100 mL three-neck glass flask, stir at 120° C. and vacuumize for half an hour for degassing; then, introduce high-purity argon into a reaction system, raise the reaction temperature raised to 180° C., and heat the reaction system and stir until PbBr₂ is completely dissolved; next, well preheat 1 mL of cesium oleate precursor solution with a concentration of 0.5 mol/L on a heating plate at 70° C. and then quickly inject into the above-mentioned three-neck glass flask with a syringe, and after 10 s of reaction, place the three-neck glass flask in ice water prepared in advance and cool to room temperature; and wash the reaction solution and purify twice with methyl acetate and toluene by means of precipitation, centrifugation and redispersion to obtain CsPbBr₃ nanocrystals in Comparative example 3 dispersed in a toluene solution.

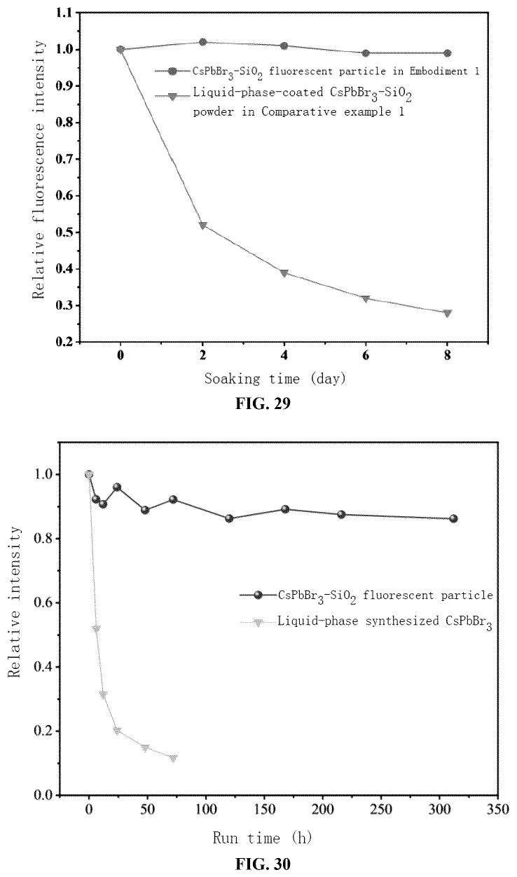

The parameters and performances of the products prepared in various examples (Embodiment 1 to Embodiment 16) and various comparative examples (Comparative example 1 to Comparative example 3) are measured as follows:
(1) the morphologies and sizes of the products in various embodiments and various comparative examples (Comparative example 1 and Comparative example 2) are measured by transmission electron microscopy (TEM), and the results are shown in Table 1;
(2) the densities of the products in various embodiments and various comparative examples (Comparative example 1 and Comparative example 2) are measured by a fully automatic true density tester, and the results are shown in Table 1;
(3) the specific surface areas of the products in various embodiments and various comparative examples (Comparative example 1 and Comparative example 2) are measured according to a BET specific surface area test method using a fully automatic specific surface and porosity analyzer, and the results are shown in Table 1; since CsPbBr₃ nanocrystals dispersed in a toluene solution are obtained from Comparative example 3 and are in a colloidal state, their density and specific surface area are not measured;
(4) stability measurement: the products in various embodiments and various comparative examples are soaked in a 1 mol/L hydrochloric acid solution for 60 days, the fluorescence intensity is then measured, and the results are shown in Table 1; in addition, FIG. 29 is a schematic diagram of the variations in the fluorescence intensity of composite particles in Embodiment 1 and Comparative example 1 over time which are impregnated in a hydrochloric acid solution; and
(5) aging test: the composite particles in Embodiment 1, Comparative example 1 and Comparative example 3 are respectively encapsulated on an LED chip, the aging test is carried out at a current of 20 mA, the light attenuation is observed, and the results are shown in Table 1. In addition, FIG. 30 is a comparative diagram of light attenuation of the CsPbBr₃—SiO₂ composite particle in Embodiment 1 of the present disclosure and CsPbBr₃ nanocrystals in Comparative example 3.

TABLE 1

| | | Average | | | Specific | | | |
|---|---|---|---|---|---|---|---|---|
| | | particle | Average | | surface | | | |
| | | size of | particle | Density of | area of | Color of | | |
| | Shape of | composite | size of | composite | composite | compound | Stability of | |
| | composite | particle | nanocrystals | particle | particle | particle | composite | |
| | particle | (nm) | (nm) | (g/cm³) | (m²/g) | powder | particle | Aging test results |
| Embodiment 1 | Approximately | About 200 | 7.6 | 2.24 | 102.3 | Yellow | After soaking | Run for 312 h |
| | spherical | | | | | green | for 60 days, | with fluorescence |
| | | | | | | | there was no | intensity of 86% |
| | | | | | | | fluorescence | of initial value |
| | | | | | | | attenuation | |
| Embodiment 2 | Approximately | About 200 | 7.2 | 2.20 | 112.2 | Yellow | After soaking | / |
| | spherical | | | | | green | for 60 days, | |
| | | | | | | | there was no | |
| | | | | | | | fluorescence | |
| | | | | | | | attenuation | |
| Embodiment 3 | Approximately | About 200 | 9.8 | 2.26 | 62.3 | Yellow | After soaking | / |
| | spherical | | | | | green | for 60 days, | |
| | | | | | | | there was no | |
| | | | | | | | fluorescence | |
| | | | | | | | attenuation | |
| Embodiment 4 | Approximately | About 200 | 6.9 | 2.30 | 81.2 | Orange | After soaking | / |
| | spherical | | | | | red | for 60 days, | |
| | | | | | | | there was no | |
| | | | | | | | fluorescence | |
| | | | | | | | attenuation | |
| Embodiment 5 | Approximately | About 200 | 7.0 | 2.24 | 89.2 | Pink | After soaking | / |
| | spherical | | | | | orange | for 60 days, | |
| | | | | | | | there was no | |
| | | | | | | | fluorescence | |
| | | | | | | | attenuation | |
| Embodiment 6 | Approximately | About 200 | 13.9 | 2.32 | 69.8 | Brown | After soaking | / |
| | spherical | | | | | | for 60 days, | |
| | | | | | | | there was no | |
| | | | | | | | fluorescence | |
| | | | | | | | attenuation | |
| Embodiment 7 | Approximately | About 110 | 7.5 | 2.25 | 82.6 | Yellow | After soaking | / |
| | spherical | | | | | green | for 60 days, | |
| | | | | | | | there was no | |
| | | | | | | | fluorescence | |
| | | | | | | | attenuation | |
| Embodiment 8 | Approximately | About 200 | 7.3 | 2.21 | 108.1 | Yellow | After soaking | / |
| | spherical | | | | | green | for 60 days, | |
| | | | | | | | there was no | |
| | | | | | | | fluorescence | |
| | | | | | | | attenuation | |
| Embodiment 9 | Approximately | About 200 | 7.8 | 2.29 | 98.3 | Yellow | After soaking | / |
| | spherical | | | | | green | for 60 days, | |
| | | | | | | | there was no | |
| | | | | | | | fluorescence | |
| | | | | | | | attenuation | |
| Embodiment 10 | Approximately | About 475 | 7.2 | 2.21 | 52.6 | Yellow | After soaking | / |
| | spherical | | | | | green | for 60 days, | |
| | | | | | | | there was no | |
| | | | | | | | fluorescence | |
| | | | | | | | attenuation | |
| Embodiment 11 | Approximately | About 56 | 7.8 | 2.16 | 126.3 | Yellow | After soaking | / |
| | spherical | | | | | green | for 60 days, | |
| | | | | | | | there was no | |
| | | | | | | | fluorescence | |
| | | | | | | | attenuation | |
| Embodiment 12 | Approximately | About 162 | 2.8 | 2.20 | 75.2 | Yellow | After soaking | / |
| | spherical | | | | | green | for 60 days, | |
| | | | | | | | there was no | |
| | | | | | | | fluorescence | |
| | | | | | | | attenuation | |
| Embodiment 13 | Approximately | About 115 | 7.5 | 2.15 | 130.6 | Yellow | After soaking | / |
| | spherical, | | | | | green | for 60 days, | |
| | slightly | | | | | | there was no | |
| | irregular | | | | | | fluorescence | |
| | | | | | | | attenuation | |
| Embodiment 14 | Approximately | About 200 | 9.6 | 2.28 | 70.2 | Yellow | After soaking | / |
| | spherical | | | | | green | for 60 days, | |
| | | | | | | | there was no | |
| | | | | | | | fluorescence | |
| | | | | | | | attenuation | |
| Embodiment 15 | Approximately | About 200 | 7.2 | 2.20 | 53.6 | Yellow | After soaking | / |
| | spherical | | | | | green | for 60 days, | |
| | | | | | | | there was no | |
| | | | | | | | fluorescence | |
| | | | | | | | attenuation | |
| Embodiment 16 | Approximately | About 200 | 7.5 | 2.28 | 51.2 | Yellow | After soaking | / |
| | spherical | | | | | green | for 60 days, | |
| | | | | | | | there was no | |
| | | | | | | | fluorescence | |
| | | | | | | | attenuation | |
| Comparative | Approximately | About 300 | 8.0 | 1.69 | 183.1 | Yellow | After soaking | Run for 72 h |
| example 1 | spherical | | | | | green | for 60 days, | with fluorescence |
| | | | | | | | the | attenuation to 20% |
| | | | | | | | fluorescence | of initial value |
| | | | | | | | intensity was | |
| | | | | | | | reduced to 28% | |
| | | | | | | | of initial value | |
| Comparative | Irregularly | >1000 | 9.6 | 2.52 | 11.5 | Yellow | After soaking | / |
| example 2 | blocky | | | | | green | for 60 days, | |
| | | | | | | | there was no | |
| | | | | | | | fluorescence | |
| | | | | | | | attenuation | |
| Comparative | / | / | 7.8 | / | / | / | After soaking | Run for 72 h |
| example 3 | | | | | | | for 60 days, | with fluorescence |
| | | | | | | | there was no | attenuation to 14% |
| | | | | | | | fluorescence | of initial value |
| | | | | | | | intensity | |

In addition, by taking the CsPbBr₃—SiO₂ composite particle in Example 1 and the CsPbBr₃—SiO₂ fluorescent powder in Comparative example 2 as examples, the solution processability test is carried out as follows:

### (1) Preparation of Nanocrystal Ink

Add 200 mg of CsPbBr₃—SiO₂ composite particle in Embodiment 1 and 200 mg of CsPbBr₃—SiO₂ fluorescent powder in Comparative example 2 respectively to 50 mL of ethanol for mixing, and sonicate for 200 min; and take a supernatant to obtain nanocrystal ink (hereinafter referred to as the nanocrystal ink in Embodiment 1) prepared from the CsPbBr₃—SiO₂ composite particle in Embodiment 1 and nanocrystal ink (hereinafter referred to as the nanocrystal ink in Comparative example 2) prepared from the CsPbBr₃—SiO₂ fluorescent powder in Comparative example 2 of the present disclosure.

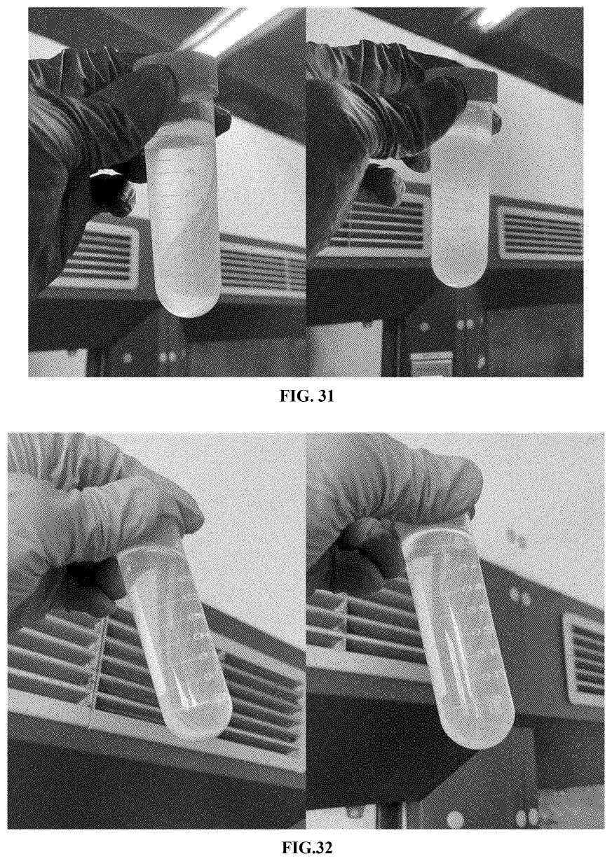

FIG. 31 is a schematic diagram of the nanocrystal ink in Example 1 which is allowed to stand for 30 min under natural light and ultraviolet light. FIG. 32 is a schematic diagram of nanocrystal ink in Comparative example 2 which is allowed to stand for 30 min under natural light and ultraviolet light.

### (2) Preparation of Color Transformation Layer

Mix the nanocrystal ink in Embodiment 1 and the nanocrystal ink in Comparative example 2 uniformly with an ultraviolet curing adhesive (UV adhesive), respectively; take 0.5 mL of uniformly mixed liquid, add dropwise to 1-inch calcium sodium glass which is cleaned, dried and washed with ozone, spin-coated at a speed of 3000 rpm for 30 s, and annealed at 95° C. for 1 min to obtain a thin film; cure the thin film to obtain a color transformation layer (hereinafter referred to as the color transformation layer in Embodiment 1) prepared from the nanocrystal ink in Embodiment 1 and a color transformation layer (hereinafter referred to as the color transformation layer in Comparative example 2) prepared from the nanocrystal ink in Comparative example 2.

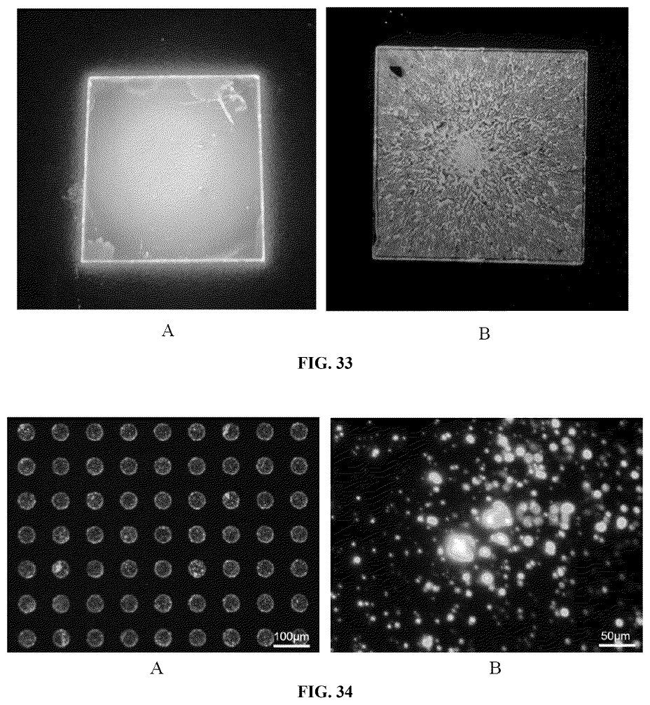

FIG. 33 is a schematic diagram illustrating a color transformation layer. FIG. A on the left side of FIG. 33 is a schematic diagram of the color transformation layer in Embodiment 1, and FIG. B on the right side is a schematic diagram of the color transformation layer in Comparative example 2.

### (3) Preparation of Patterned Color Transformation Layer for Micro-LED

Mix the nanocrystal ink in Example 1 and the nanocrystal ink in Comparative example 2 uniformly with SU-8 2002 photoresist, respectively; and take 0.5 mL of uniformly mixed liquid, add dropwise to 1-inch calcium sodium glass which is cleaned, dried and washed with ozone, spin-coated at a speed of 3000 rpm for 30 s, and annealed at 95° C. for 1 min to obtain a thin film; flush the thin film with a light film plate and undergo a standard photoetching process to obtain a patterned color transformation layer for Micro-LED (hereinafter referred to as a patterned color transformation layer in Embodiment 1) prepared from the nanocrystal ink in Embodiment 1 and a patterned color transformation layer for Micro-LED (hereinafter referred to as a patterned color transformation layer in Comparative example 2) prepared from the nanocrystal ink in Comparative example 2.

FIG. 34 is a schematic diagram illustrating a patterned color transformation layer. FIG. A on the left side of FIG. 34 is a schematic diagram of the patterned color transformation layer in Embodiment 1, and FIG. B on the right side is a schematic diagram of the patterned color transformation layer in Comparative example 2.

It should be noted that in the embodiment s, the comparative examples and the above measurement process in the present disclosure, if not specifically indicated, the used reagents and instruments are commercially available products.

The following is a detailed analysis of the experimental results.

As may be seen from Table 1, the composite particles obtained in various embodiment s (Embodiment 1 to Embodiment 16) have particle sizes in the range of 20 nm to 500 nm; the nanocrystals have particle sizes in the range of 1 nm to 50 nm, a density of above 1.8 g/cm³ and a specific surface area in the range of 8 m²/g to 200 m²/g; and each example was soaked in a hydrochloric acid solution for 60 days without any fluorescence attenuation phenomenon, indicating that the nanocrystals are densely coated with oxides, achieving strong anti-interference capabilities and stability of the composite particles.

In Embodiment 13, after a surfactant, a catalyst, an oxide precursor and a fluorescent material precursor are mixed for a predetermined time, a bottom precipitate (solid mixture) in the mixed solution is separated by means of centrifugation. As may be seen from FIG. 24, the composite particle formed in Embodiment 13 is still approximately spherical and slightly irregular. By comparing Embodiment 1 with Embodiment 13 and comparing FIG. 5 with FIG. 24, it may be seen that the morphology of the composite particle formed in Embodiment 1 is more regular, that is, the composite particle finally formed by means of precipitation from the mixed solution using an organic solvent is more regular.

In Embodiment 15, silicon oxide microspheres modified with dry K₂CO₃ (fluxing agent) are ground and mixed with the fluorescent material precursor to obtain a solid powder. Because the silicon oxide microspheres and the fluorescent material precursor are only ground and mixed, the fluorescent material precursor almost does not enter the silicon oxide microspheres, that is, there is no or only a very small amount of fluorescent material precursor inside the silicon oxide microspheres during calcination. However, it may be seen from FIG. 26 that the composite particle in Embodiment 15 still has a certain fluorescence intensity, because the fluorescent material precursor located outside the silicon oxide microspheres is heated to migrate into the silicon oxide microspheres to form nanocrystals. Therefore, the prepared composite particle may contain a certain amount of nanocrystals and has certain fluorescence intensity. Moreover, it may also be seen from FIG. 26 that the fluorescence intensity of the composite particle in Embodiment 15 is weaker than that of Embodiment 1, indicating that mixing the oxide material and the fluorescent material precursor in a liquid-phase environment may facilitate the entry of the fluorescent material precursor into the internal ducts of the oxide microspheres, and the fluorescent material precursor located inside the ducts during calcination may generate more fluorescent nanocrystals, so that the formed composite particle has stronger fluorescence intensity.

In Embodiment 16, ultraviolet-visible absorption spectra of the composite particle synthesized in Embodiment 16 and the composite particle in Embodiment 3 are compared, and the results are shown in FIG. 27, which may prove that the composite particle synthesized in Embodiment 16 is the CsPbBr₃@Cs₄PbBr₆—SiO₂ composite particle, which contains nanocrystals with perovskite structures ABX₃ and A₄BX₆ at the same time.

In Comparative example 1, silicon dioxide is synthesized by a room-temperature hydrolysis method, and CsPbBr₃ quantum dots are coated with the silicon dioxide by using a solution coating method. It may be seen from FIG. 29 that when CsPbBr₃—SiO₂ in Comparative example 1 is soaked in a hydrochloric acid solution, the relative fluorescence intensity of CsPbBr₃—SiO₂ in Comparative example 1 decreases significantly with the soaking time, indicating that a silicon dioxide protection layer coated by hydrolysis at room temperature is relatively loose, and hydrochloric acid may penetrate and further destroy CsPbBr₃ nanocrystals, resulting in poor stability.

Although the density of the CsPbBr₃—SiO₂ fluorescent powder prepared by the high-temperature solid-phase method in Comparative example 2 is greater than 1.8 g/cm³, there is no light attenuation phenomenon after being soaked in a hydrochloric acid solution for 60 days, indicating that the oxide in Comparative example 2 has a better protection effect on the nanocrystals. However, as may be seen from FIG. 28, the morphology of CsPbBr₃—SiO₂ in Comparative example 2 is irregularly blocky, and the overall particle size is basically greater than 1000 nm, so the CsPbBr₃—SiO₂ fluorescent powder in Comparative example 2 doses not perform well while being applied in specific scenarios.

Specifically, as may be seen from FIG. 31 and FIG. 32, the nanocrystal ink in Embodiment 1 has almost no precipitation phenomenon after standing for 30 min, indicating that the ink has good dispersion and stability. However, most of the nanocrystal ink in Comparative example 2 settles after standing for 30 min, indicating that it is difficult for the CsPbBr₃—SiO₂ fluorescent powder in Comparative example 2 to form uniform, dispersible and stable ink.

As may be seen from FIG. 33, the color transformation layer in Embodiment 1 is relatively uniform, while the color transformation layer in Comparative example 2 has obvious graininess and uneven thin film, indicating that the CsPbBr₃—SiO₂ fluorescent powder in Comparative example 2 cannot be used to prepare a uniform and high-quality color transformation layer.

As may be seen from FIG. 34, the diameter of each circular pixel point of the patterned color transformation layer in Embodiment 1 is about 50 m, and the pixel points are neatly spaced from each other. However, a pattern resolution in the patterned color transformation layer in Comparative example 2 is relatively low, and the pixel points are adhered and agglomerated together and cannot be precisely patterned. This situation occurs mainly because the CsPbBr₃—SiO₂ fluorescent powder in Comparative example 2 has uncontrollable morphology and relatively large particle size, and thus cannot be patterned into tiny pixel points.

Comparative example 3 is CsPbBr₃ nanocrystals coated without oxides. As may be seen from FIG. 30, after the CsPbBr₃—SiO₂ composite particle obtained in Embodiment 1 is run for 312 h, the fluorescence intensity is still 86% of an initial value; and after the CsPbBr₃ nanocrystals in Comparative example 3 are run for 72 h, the fluorescence is decayed to 14% of the initial value, indicating that the CsPbBr₃—SiO₂ composite particle in Embodiment 1 has excellent light stability. That is, the stability and the service life of the CsPbBr₃ nanocrystals may be improved and prolonged through the dense coating of the CsPbBr₃ nanocrystals with SiO₂.

Various embodiments of the disclosure may have one or more of the following effects. In some embodiments, the present disclosure may provide a preparation method of a fluorescent composite particle with strong stability and small particle size, as well as a fluorescent composite particle with a controllable morphology. In other embodiments, the morphologies of the composite particles may be controlled through the two preparation methods of the present disclosure, and the composite particles obtained by various embodiment s (Embodiment 1 to Embodiment 16) have small particle size and strong stability, as well as good fluorescent characteristics and photoelectric properties, and thus may be applied in the fields of display, fluorescence imaging and illumination, etc. In contrast, the products obtained in various Comparative examples (Comparative example 1 to Comparative example 3) cannot simultaneously achieve the performances and effects of the composite particles obtained in the above examples.

Although the present disclosure has been specifically described above with reference to the accompanying drawings and examples, it may be understood that the above description does not limit the present disclosure in any form. Those skilled in the art may make modifications and changes of the present disclosure as required without departing from the essential spirit and scope of the present disclosure, and these modifications and changes all fall within the scope of the present disclosure.

Many different arrangements of the various components depicted, as well as components not shown, are possible without departing from the spirit and scope of the disclosure. Embodiments of the disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the disclosure.

It will be understood that certain features and subcombinations are of utility and may be employed without reference to other features and subcombinations and are contemplated within the scope of the claims. Unless indicated otherwise, not all steps listed in the various figures need be carried out in the specific order described.

1. A fluorescent composite particle, comprising a fluorescent material having a plurality of fluorescent nanocrystals, and an oxide material, wherein the fluorescent material is coated with the oxide material, a molar ratio of the fluorescent material to the oxide material is ranged from 10:1 to 1:100, and the fluorescent composite particle has a particle size of 20 nm to 500 nm, a density of 1.8 g/cm³ to 7 g/cm³, and a specific surface area of 8 m²/g to 200 m²/g.

2. The fluorescent composite particle according to claim 1, wherein the fluorescent nanocrystal has a particle size of 1 nm to 50 nm.

3. The fluorescent composite particle according to claim 2, wherein the plurality of fluorescent nanocrystals are uniformly dispersed inside the oxide material, and a difference between the particle sizes of any two fluorescent nanocrystals in the plurality of fluorescent nanocrystals is ranged from 0 nm to 25 nm.

4. The fluorescent composite particle according to claim 1, wherein the fluorescent material has cations, and oxygen ions of the oxide material form bonds with the cations of the fluorescent material for lattice anchoring.

5. The fluorescent composite particle according to claim 1, wherein:
the fluorescent material comprises fluorescent nanocrystals having a perovskite structure ABX₃, and
A is Li, Na, K, Rb or Cs, B is Ge, Sn, Pb, Cu, Mn, Ca, Sr or Ba, and X is F, Cl, Br or I.

6. The fluorescent composite particle according to claim 1, wherein:
the fluorescent material comprises fluorescent nanocrystals having a perovskite structure ABX₃ modified with a halide; the halide has a perovskite-type or non-perovskite-type structure;
the halide has a structure of B′X₂, A′B′X₃, A′₄B′X₆ or A′B′₂X₅, and A′ and A are each independently Cs, Rb or K;
B′ and B are each independently Pb, Zn, Ca or Ba; and
X is Cl, Br or I.

7. The fluorescent composite particle according to claim 1, wherein the fluorescent material comprises fluorescent nanocrystals having a binary structure Dⁿ⁺Yⁿ⁻, and wherein n is an integer of 1-10, a molar ratio of elements D to Y is 1:1, and D is Zn, Cd, Hg, Al, Ga or In; and Y is S, Se, Te, N, P, As or Sb.

8. The fluorescent composite particle according to claim 1, wherein the fluorescent material comprises fluorescent nanocrystals having an IB-IIIA-VIA family ternary compound structure G⁺M³⁺(N²⁻)₂, and wherein G⁺ is Cu⁺ or Ag⁺; M³⁺ is In³⁺, Ga³⁺ or Al³⁺; N²⁻ is S²⁻ or Se²⁻; and a molar ratio of G⁺ to M³⁺ to N²⁻ is 0.5:0.5:1.

9. The fluorescent composite particle according to claim 1, wherein the oxide material is selected from any one of silicon oxide, aluminum oxide, titanium oxide, zirconium oxide, zinc oxide, tin oxide, and transition metal oxide.

10. A preparation method of a fluorescent composite particle, comprising following steps:
preparing a fluorescent material precursor, and adding a surfactant to the fluorescent material precursor to obtain a first mixture;
adding an oxide material precursor to the first mixture and allowing the oxide material precursor to undergo in-situ hydrolysis to obtain a second mixture, wherein a molar ratio of the fluorescent material precursor to the oxide material precursor is ranged from 10:1 to 1:50; and
separating a solid mixture in the second mixture, calcining the solid mixture for a predetermined time under a predetermined temperature condition to obtain the fluorescent composite particle comprising an oxide material and a fluorescent material, wherein the fluorescent material is coated with the oxide material in the fluorescent composite particle, and the fluorescent composite particle has a particle size of 20 nm to 500 nm, a density of 1.8 g/cm³ to 7 g/cm³, and a specific surface area of 8 m²/g to 200 m²/g.

11. The preparation method according to claim 10, wherein the surfactant comprises one or more of an alkyl quaternary ammonium salt surfactant, a long-chain alkane epoxy ether, and a polyethylene oxide-polypropylene oxide block copolymer, and a molar ratio of the oxide material precursor to the surfactant is ranged from 0.5:1 to 50:1.

12. The preparation method according to claim 10, wherein the predetermined temperature is ranged from 300° C. to 1200° C., and the predetermined time is ranged from 1 min to 600 min.

13. The preparation method according to claim 10, wherein the oxide material precursor comprises one or more of a silicon-containing compound, an aluminum-containing compound, a titanium-containing compound, a zirconium-containing compound, a zinc-containing compound, a tin-containing compound, a nickel-containing compound, a lead-containing compound, a cobalt-containing compound, a cerium-containing compound, a chromium-containing compound and an indium-containing compound.

14. The preparation method according to claim 10, wherein the fluorescent material precursor comprises one or more of an AX precursor, a BX₂ precursor and a B′X₂ precursor, wherein A is Li, Na, K, Rb or Cs; B′ and B are different and each independently are Ge, Sn, Pb, Cu, Mn, Ca, Sr or Ba; and X is F, Cl, Br or I.

15. The preparation method according to claim 10, wherein:
the fluorescent material precursor comprises a cationic precursor and an anionic precursor in a molar ratio of 1:1;
the cationic precursor is used to supply cationic Dⁱ⁺, wherein i is an integer of 1-10;
the cationic precursor is selected from oxides, nitrides, phosphides, sulfides, selenides, hydrochlorides, acetates, carbonates, sulfates, phosphates, nitrates and their hydrates of following elements: Zn, Cd, Hg, Al, Ga, and In;
the anionic precursor is used to supply anionic Yⁿ⁻, wherein n is an integer of 1-10; and
the anionic precursor is selected from elementary substances and inorganic salts of following elements: S, Se, Te, N, P, As, and Sb.

16. The preparation method according to claim 10, wherein, before the solid mixture is separated, an organic solvent is added to the second mixture first to terminate a hydrolysis reaction of the oxide material precursor, and then separated to obtain the solid mixture.

17. The preparation method according to claim 16, wherein the organic solvent comprises one or more of acetone, methanol, ethanol and tetrahydrofuran, and a volume ratio of the organic solvent to the second mixture is ranged from 1:1 to 10:1.

18. The preparation method according to claim 10, wherein the solid mixture in the second mixture is separated by segmented drying, wherein the segmented drying comprises a primary evaporation and a secondary evaporation, and a drying temperature of the primary evaporation is lower than a drying temperature of the secondary evaporation.

19. The preparation method according to claim 18, wherein:
the drying temperature of the primary evaporation is ranged from 30° C. to 50° C., and an evaporation time is ranged from 1 h to 30 h; and
the drying temperature of the secondary evaporation is ranged from 60° C. to 90° C., and the evaporation time is ranged from 1 h to 20 h.

20. A preparation method of a fluorescent composite particle, comprising following steps:
preparing a mixture comprising a fluorescent material precursor, an oxide material, and a fluxing agent, wherein a molar ratio of the fluorescent material precursor to the oxide material is ranged from 10:1 to 1:100, the oxide material is oxide microspheres having ordered mesopores, and the fluxing agent is present in mesopore ducts of the oxide microspheres in the mixture; and
calcining the mixture for a predetermined time under a predetermined temperature condition to obtain the fluorescent composite particle comprising an oxide material and a fluorescent material, wherein the fluorescent material is coated with the oxide material in the fluorescent composite particle, and the fluorescent composite particle has a particle size of 20 nm to 500 nm, a density of 1.8 g/cm³ to 7 g/cm³, and a specific surface area of 8 m²/g to 200 m²/g.

21. The preparation method according to claim 20, wherein:
before the mixture is calcined, the mixture is dissolved in a first solvent to obtain a first mixture;
the first mixture is dried to obtain a mixture powder; and
the mixture powder is then calcined.

22. The preparation method according to claim 20, wherein the fluorescent material precursor is present in the mesopore ducts of the oxide microspheres in the mixture.

23. The preparation method according to claim 20, wherein the fluxing agent is a potassium salt, a sodium salt or a rubidium salt, and a molar ratio of the fluxing agent to the fluorescent material precursor is ranged from 0.1:1 to 2:1.

24. The preparation method according to claim 20, wherein the oxide microsphere has a particle size of 20 nm to 500 nm, and the mesopore of the oxide microspheres has a pore size of 2 nm to 10 nm.

25. The preparation method according to claim 20, wherein the predetermined temperature is ranged from 300° C. to 1200° C., and the predetermined time is ranged from 1 min to 600 min.
